(19) United States
(12) Patent Application Publication
(10) Pub. No.: US 2016/0080374 A1
(43) Pub. Date: Mar. 17, 2016

(54) OUTPUT SYSTEM, OUTPUT METHOD, OUTPUT DATA STORAGE APPARATUS, AND OUTPUT DATA RELAY APPARATUS

(71) Applicant: Naritake KONDOH, Kanagawa (JP)

(72) Inventor: Naritake KONDOH, Kanagawa (JP)

(73) Assignee: RICOH COMPANY, LTD., Tokyo (JP)

(21) Appl. No.: 14/851,070

(22) Filed: Sep. 11, 2015

(30) Foreign Application Priority Data
Sep. 16, 2014 (JP) 2014-187362

(51) Int. Cl. H04L 29/06

(52) U.S. Cl. CPC H04L 63/0869; H04L 63/10

(57) ABSTRACT

An output system includes a first system that performs authentication using user information including first authentication information and outputs from an output apparatus output data specified using the first authentication information, and a second system that provides the output data to the first system. The second system includes a storage unit that stores output data in association with pre-authentication information, a unit that provides the pre-authentication information to the first system, and a unit that provides the output data to the first system. The first system includes a storage unit that stores the first authentication information, an authentication unit that performs authentication with respect to the pre-authentication information provided by the second system, a cooperation unit that specifies the output data associated with the pre-authentication information that has been successfully authenticated, and a storage unit that stores the specified output data in association with the first authentication information.

### BACKGROUND OF THE INVENTION

1. Field of the Invention

The present invention relates to an output system, an output method, an output data storage apparatus, and an output data relay apparatus.

2. Description of the Related Art

For example, systems are known that are configured to store a print job that is received from a terminal apparatus such as a PC in a print server that is provided on a public network such as the Internet rather than immediately printing the print job. In such systems, a print job may be printed by an image forming apparatus such as a multifunction peripheral (MFP) when the print job is selected by a user from a print job list, for example. When printing a print job that is stored in a print server from an image forming apparatus in such systems, user authentication is generally performed for information security purposes.

In a case where management of user authentication and authentication information (hereinafter referred to as “user authentication management”) is implemented in an authentication server on a private network, such as a corporate network, for example, the user authentication management implemented on the private network may be used in a print server that is provided on a public network, for example.

However, when authentication information for user authentication management that is implemented on a private network is duplicated and used in a public network such as the Internet, dual management of the authentication information within the system may be necessary, and such a scheme may be undesirable from a security standpoint as well.

On the other hand, in a case where the authentication information of user authentication management that is implemented on the private network is not duplicated, functions such as submitting a print job to a print server from a public network may be restricted.

A print system is known in which a user acquires a job identifier (PIN code) associated with a print job upon submitting the print job, and the user enters the job identifier upon printing the submitted print job from an image forming apparatus. In such a system, a stored print job may be acquired and printed without requiring user authentication management (see e.g. Japanese Laid-Open Patent Publication No. 2014-52779).

However, in the case of using a job identifier such as a PIN code as described above, user convenience may be compromised. For example, in the system as described above, the user is required to input a job identifier. As the number of users using the system increases, the number of jobs that may be stored in the system is also expected to increase. In turn, the number of digits constituting a job identifier may have to be increased in order to maintain the uniqueness of each job identifier associated with a stored print job, and a large operation burden may be imposed on the user inputting the job identifier. Also, in the case of using a PIN code, a user cannot be authenticated (identified). Thus, in a print system that enables a job submitted to a server on a public network to be printed at an image forming apparatus provided on a private network, user authentication cannot be performed in the private environment.

### SUMMARY OF THE INVENTION

An aspect of the present invention is directed to providing an output system, an output method, an output data storage apparatus, and an output data relay apparatus that are capable of implementing efficient user authentication management, and outputting output data stored by a user on a public network through simple user authentication management.

According to one embodiment of the present invention, an output system is provided that includes a first system and a second system. The first system is configured to perform user authentication using user information including first authentication information, and output from an output apparatus output data specified using the first authentication information. The second system is distinct from the first system and is configured to store output data received from a terminal apparatus that is operated by a user and provide the output data to the first system. The second system includes a storage unit configured to receive from the terminal apparatus the output data and pre-authentication information to be authenticated at the first system, and store the output data and the pre-authentication information in association with each other; an authentication information management unit configured to provide the pre-authentication information stored in the storage unit to the first system in response to a request from the first system; and an output data management unit configured to provide the output data stored in the storage unit to the first system in response to a request from the first system. The first system includes an authentication information storage unit configured to store the user information including the first authentication information; a first authentication unit configured to perform authentication with respect to the pre-authentication information that is provided by the second system based on the user information including the first authentication information stored in the authentication information storage unit; a cooperation unit configured to specify the output data that is associated with the pre-authentication information that has been successfully authenticated by the first authentication unit as the output data to be output by the first system; and an output data storage unit configured to store the specified output data in association with the first authentication information included in the user information used to authenticate the pre-authentication information that is associated with the specified output data.

### BRIEF DESCRIPTION OF THE DRAWINGS

FIG. 1 illustrates an exemplary configuration of a print system according to an embodiment of the present invention;

FIG. 2 illustrates an exemplary hardware configuration of a computer according to an embodiment of the present invention;

FIG. 3 illustrates an exemplary hardware configuration of an image forming apparatus according to an embodiment of the present invention;

FIG. 4 is a block diagram illustrating an exemplary functional configuration of a relay server apparatus;

FIG. 5 is a block diagram illustrating an exemplary functional configuration of an authentication server apparatus;

FIG. 6 is a block diagram illustrating an exemplary functional configuration of an image forming apparatus;

FIG. 7 is a block diagram illustrating an exemplary functional configuration of a print server apparatus;

FIG. 8 is a block diagram illustrating an exemplary functional configuration of a temporary storage service apparatus;

FIG. 9 is a block diagram illustrating an exemplary functional configuration of a terminal apparatus;

FIG. 10 is a table illustrating an exemplary configuration of authentication information;

FIG. 11 is a table illustrating an exemplary configuration of information stored in a storage unit of the temporary storage service apparatus;

FIG. 12 is a table illustrating an exemplary configuration of information stored in a print data storage unit of the print server apparatus;

FIG. 13 schematically illustrates overall process operations of the print system according to a first embodiment of the present invention;

FIG. 14 is a sequence chart illustrating a submission/cooperation process of the print system according to the first embodiment;

FIG. 15 is a sequence chart illustrating a print process of the print system according to the first embodiment;

FIG. 16 schematically illustrates overall process operations of the print system according to a second embodiment of the present invention;

FIG. 17 is a block diagram illustrating another exemplary functional configuration of the temporary storage service apparatus;

FIG. 18 schematically illustrates overall process operations of the print system according to a third embodiment of the present invention;

FIG. 19 is a sequence chart illustrating a submission process of the print system according to the third embodiment;

FIG. 20 schematically illustrates overall process operations of the print system according to a fourth embodiment of the present invention;

FIG. 21 is a sequence chart illustrating a submission/cooperation process of the print system according to the fourth embodiment;

FIG. 22 is a block diagram illustrating another exemplary functional configuration of the temporary storage service apparatus;

FIG. 23 is a table illustrating an exemplary configuration of information stored in a user information history management unit of the temporary storage service apparatus;

FIG. 24 is a sequence chart illustrating a submission process of the print system according to a fifth embodiment of the present invention;

FIG. 25 is a sequence chart illustrating a cooperation process of the print system according to the fifth embodiment;

FIG. 26 schematically illustrates overall process operations of the print system according to a sixth embodiment of the present invention;

FIG. 27 is a block diagram illustrating another exemplary configuration of the temporary storage service apparatus;

FIG. 28 is a table illustrating an exemplary configuration of authentication information used by an authentication unit of the temporary storage service apparatus;

FIG. 29 is a sequence chart illustrating a submission/cooperation process of the print system according to the sixth embodiment;

FIG. 30 schematically illustrates overall process operations of the print system according to a seventh embodiment of the present invention;

FIG. 31 is a block diagram illustrating another exemplary functional configuration of the temporary storage service apparatus;

FIG. 32 is a table illustrating an exemplary configuration of information managed by a terminal ID management unit of the temporary storage service apparatus;

FIG. 33 is a sequence chart illustrating a submission process of the print system according to the seventh embodiment;

FIG. 34 schematically illustrates overall process operations of the print system according to an eighth embodiment of the present invention;

FIG. 35 is a block diagram illustrating another exemplary functional configuration of the authentication server apparatus;

FIG. 36 is a sequence chart illustrating a submission/cooperation process of the print system according to the eighth embodiment;

FIG. 37 schematically illustrates overall process operations of the print system according to a ninth embodiment of the present invention;

FIG. 38 is a block diagram illustrating another exemplary functional configuration of the authentication server apparatus;

FIG. 39 is table illustrating an exemplary configuration of information managed by a token generation unit of the authentication server apparatus;

FIG. 40 is a sequence chart illustrating a submission/cooperation process of the print system according to the ninth embodiment;

FIG. 41 schematically illustrates overall process operations of the print system according to a tenth embodiment of the present invention; and

FIG. 42 is a sequence chart illustrating a submission/cooperation process of the print system according to the tenth embodiment.

### DESCRIPTION OF THE PREFERRED EMBODIMENTS

In the following, embodiments of the present invention are described with reference to the accompanying drawings. Note that in the descriptions below, a print system 1 is illustrated as an example of an output system according to an embodiment of the present invention.

### First Embodiment

<System Configuration>

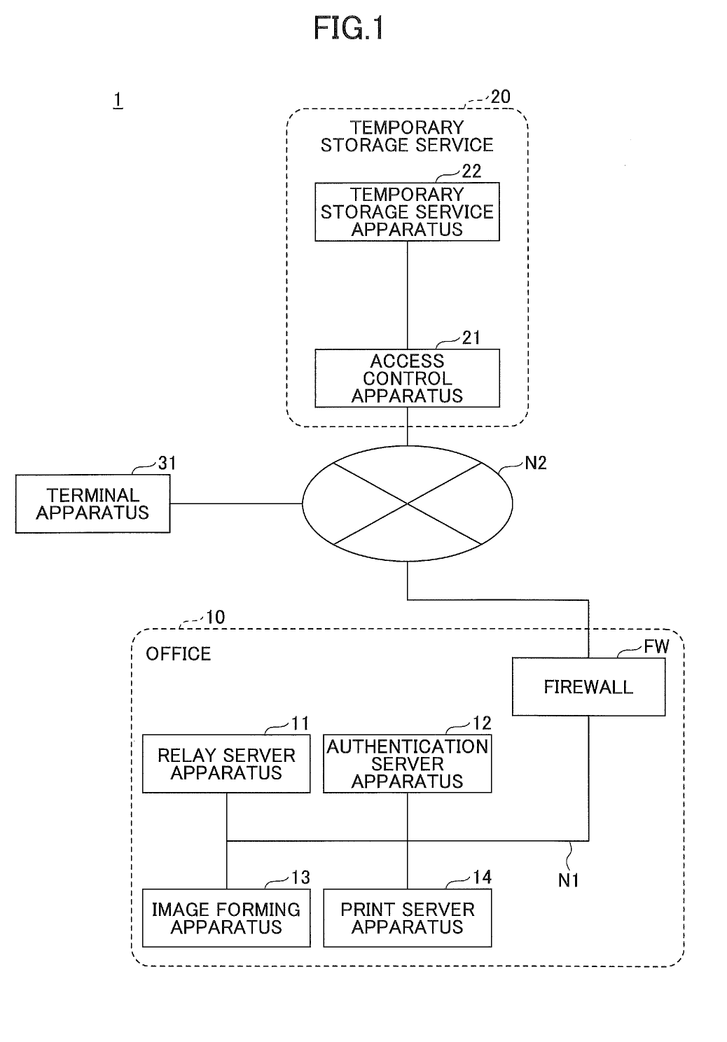

FIG. 1 illustrates an exemplary configuration of the print system 1 according to an embodiment of the present invention. In FIG. 1, the print system 1 includes an on-premises system 10, a shared system 20, and a terminal apparatus 31.

The on-premises system 10 is on a private network (e.g. corporate network) N1 within an office and cannot be accessed from an external public network N2 such as the Internet.

The shared system 20 is located outside the private network N1 and is connected to the public network N2 such as the Internet. The terminal apparatus 31 is an apparatus such as a desktop PC, a tablet PC, a notebook PC, a smart phone, or a mobile phone that is connected to the public network N2.

A firewall FW is installed in the on-premises system 10 of FIG. 1. The firewall FW restricts access from unauthorized access sources. The network N1 is a private network behind the firewall FW. A relay server apparatus 11, an authentication server apparatus 12, an image forming apparatus 13, and a print server apparatus 14 are connected to the network N1.

The relay server apparatus 11 acquires print data from a temporary storage service apparatus 22, which is described below. The authentication server apparatus 12 provides an authentication function. The image forming apparatus 13 acquires print data from the print server apparatus 14 and prints out the print data. The image forming apparatus 13 is an apparatus having a printing function such as an MFP or a laser printer, for example. Note that an output system according to an embodiment of the present invention may have an image forming function other than printing such as an image projecting function or an image display function, for example. In such a case, an apparatus such as a projector or an electronic blackboard having such image projecting function or image display function may be used as the image forming apparatus 13, for example.

Note that in the on-premises system 10 of FIG. 1, the authentication server apparatus 12, the image forming apparatus 13, and the print server apparatus 14 may operate as a pull print system of the on-premises system 10. The relay server apparatus 11, the authentication server apparatus 12, the image forming apparatus 13, and the print server apparatus 14 have communication means for establishing wireless or wired communication. Note that in the example of FIG. 1, one of each of the relay server apparatus 11, the authentication server apparatus 12, the image forming apparatus 13, and the print server apparatus 14 are illustrated. However, in other examples, multiple units of the above apparatuses may be included in the print system 1.

In FIG. 1, the shared system 20 includes an access control apparatus 21 and a temporary storage service apparatus 22. The access control apparatus 21 restricts access to the temporary storage service apparatus 22 from the network N2 using a tenant ID as described below. The temporary storage service apparatus 22 temporarily stores print data received from the terminal apparatus 31 until the relay server apparatus 11 acquires the print data.

The shared system 20 may be a system constructed by a provider that provides a temporary storage service as a cloud service, a service provided by an ASP (application service provider), or a web service, for example.

The apparatuses of the shared system 20 such as the access control apparatus 21 and the temporary storage service apparatus 22 may be implemented by one or more information processing apparatuses. That is, the apparatuses of the shared system 20 may be integrally implemented by a single information processing apparatus, or the apparatuses may be implemented in a distributed manner by a plurality of information processing apparatuses.

The terminal apparatus 31 transmits print data to the temporary storage service apparatus 22. Note that although the terminal apparatus 31 is connected to the public network N2 in the example of FIG. 1, the terminal apparatus 13 may instead be connected to the private network N1. By connecting the terminal apparatus 31 to the public network N2, print data may be transmitted from outside the office, or print data may be transmitted by an outsider such as a guest that cannot be connected to the private network N1, for example.

Note that the print system 1 according to the present embodiment is merely one illustrative example and is not intended to limit the scope of the present invention. For example, the firewall FW between the public network N2 and the private network N1 does not necessarily have to be included in other embodiments of the present invention.

<Hardware Configuration>

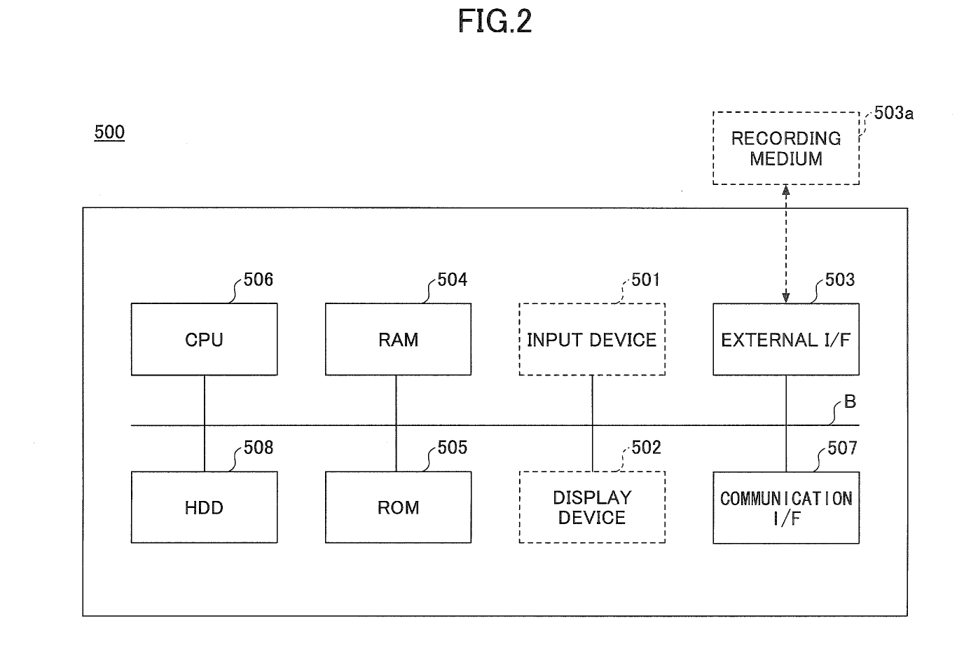

The relay server apparatus 11, the authentication server apparatus 12, the print server apparatus 14, the access control apparatus 21, the temporary storage service apparatus 22, and the terminal apparatus 31 may be implemented by a computer having a hardware configuration as illustrated in FIG. 2, for example. FIG. 2 illustrates a hardware configuration of a computer 500 according to an embodiment of the present invention.

In FIG. 2, the computer 500 includes an input device 501, a display device 502, an external I/F 503, a RAM 504, a ROM 505, a CPU 506, a communication I/F 507, and a hard disk drive (HDD) 508 that are interconnected via a bus B. Note that in some embodiments, the input device 501 and the display device 502 may be connected to the computer 500 when they need to be used, for example.

The input device 501 may include a keyboard and/or a mouse, for example, and is used to input various operation signals to the computer 500. The display device 502 may include a display, for example, and is configured to display processing results of the computer 500.

The communication I/F 507 is an interface for connecting the computer 500 to the network N1 or the network N2. In this way, the computer 500 may establish data communication with other computers via the communication I/F 507.

The HDD 508 is a nonvolatile storage device storing programs and data. The programs stored in the HDD 508 may include an operating system (OS) corresponding to basic software controlling overall operations of the computer 500, and application software providing various functions under the control of the OS, for example.

The external I/F 503 is an interface between the computer 500 and an external device. The external device may be a recording medium 503a, for example. The computer 500 may read information from and/or write information on the recording medium 503a via the external I/F 503. Specific examples of the recording medium 503a include a flexible disk, a compact disk (CD), a digital versatile disk (DVD), a SD memory card, a universal serial bus (USB) memory, and the like.

The ROM 505 is a nonvolatile semiconductor memory (storage device) that can store programs and/or data even when the power is turned off. The ROM 505 stores programs and data such as a basic input/output system (BIOS) to be executed when the computer 500 is started, OS settings, network settings, and the like. The RAM 504 is a volatile semiconductor memory (storage device) that temporarily stores programs and/or data.

The CPU 506 includes an arithmetic and logic unit that reads a program and/or data from a storage device such as the ROM 505 and/or the HDD 508, loads the program and/or data in the RAM 504, and executes processes according to the program and/or data to control the overall operations and functions of the computer 500.

The relay server apparatus 11, the authentication server apparatus 12, the print server apparatus 14, the access control apparatus 21, the temporary storage service apparatus 22, and the terminal apparatus 31 of the present embodiment may implement various processes as described below using relevant features of the hardware configuration of the computer 500 as illustrated in FIG. 2.

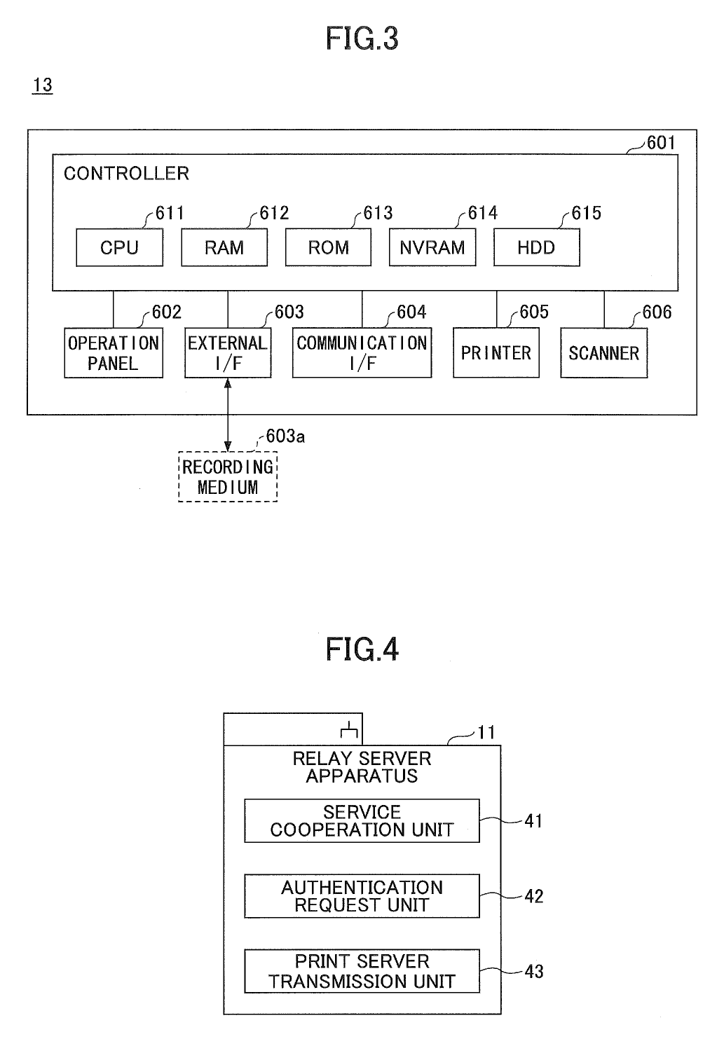

The image forming apparatus 13 of FIG. 1 may be implemented by a computer having a hardware configuration as illustrated in FIG. 3, for example. FIG. 3 illustrates an exemplary hardware configuration of the image forming apparatus 13 according to the present embodiment. In FIG. 3, the image forming apparatus 13 includes a controller 601, an operation panel 602, an external I/F 603, a communication I/F 604, a printer 605, and a scanner 606.

The controller 601 includes a CPU 611, a RAM 612, a ROM 613, a NVRAM 614, and a HDD 615. The ROM 613 stores various programs and data. The RAM 612 temporarily stores programs and data. The NVRAM 614 may store setting information and the like, for example. Also, the HDD 615 stores various programs and data.

The CPU 611 reads relevant programs, data, and/or setting information from a storage device such as the ROM 613, the NVRAM 614, and/or the HDD 615, loads the read items on the RAM 612, and executes relevant process operations to implement a function of the image forming apparatus 13 or perform overall control of the image forming apparatus 13, for example.

The operation panel 602 includes an input unit for accepting an input from a user, and a display unit for displaying items of information. The external I/F 603 is an interface with an external device. The external device may be a recording medium 603a, for example. In this way, the image forming apparatus 13 may read data from and/or write data on the recording medium 603a via the external I/F 603. The recording medium 603a may be an IC card, a flexible disk, a CD, a DVD, an SD memory card, a USB memory, or the like.

The communication I/F 604 is an interface for connecting the image forming apparatus 13 to the network N1. In this way, the image forming apparatus 13 may establish data communication with an external device via the communication I/F 604. The printer 605 is a printing apparatus for printing print data on a medium such as paper. The scanner 606 is a scanning apparatus for scanning a document to acquire image data (electronic data) of the document.

<Software Configuration>

<<Relay Server Apparatus>>

FIG. 4 is a block diagram illustrating an exemplary functional configuration of the relay server apparatus 11. The relay server apparatus 11 of FIG. 4 may execute a relevant program to implement a service cooperation unit 41, an authentication request unit 42, and a print server transmission unit 43.

The service cooperation unit 41 communicates with the temporary storage service apparatus 22. The service cooperation unit 41 acquires a user list and print data from the temporary storage service apparatus 22. The service cooperation unit 41 may establish communication with the temporary storage service apparatus 22 using a general communication protocol such as the HTTP/HTTPS, for example.

The authentication request unit 42 makes a login request (or presence confirmation request) to the authentication server apparatus 12 using user information acquired from the temporary storage service apparatus 22. Note that the authentication request unit 42 may establish communication with the authentication server apparatus 12 using a general communication protocol such as the HTTP/HTTPS to carry out authentication, or establish communication using a dedicated protocol for authentication such as the LDAP (Lightweight Directory Access Protocol) to carry out the authentication, for example. The print server transmission unit 43 transmits print data acquired from the temporary storage service apparatus 22 to the print server apparatus 14.

<<Authentication Server Apparatus>>

FIG. 5 is a block diagram illustrating an exemplary functional configuration of the authentication server apparatus 12. In FIG. 5, the authentication server apparatus 12 includes an authentication unit 51 that is implemented by executing a relevant program. The authentication unit 51 provides an authentication function. Note that the authentication unit 51 may provide a general authentication function or a unique authentication function. Also, the authentication server apparatus 12 may provide an authentication function in cooperation with a separate AD (Active Directory) server or a LDAP (Lightweight Directory Access Protocol) server, for example.

<<Image Forming Apparatus>>

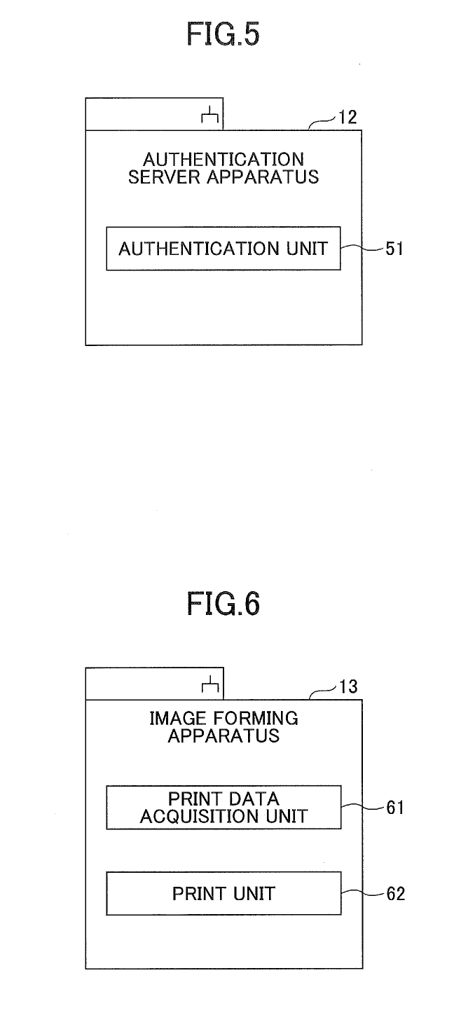

FIG. 6 is a block diagram illustrating an exemplary functional configuration of the image forming apparatus 13. In FIG. 6, the image forming apparatus 13 includes a print data acquisition unit 61 and a print unit 62 that are implemented by executing relevant programs. The print data acquisition unit 61 transmits a print data list acquisition request and a print data acquisition request to the print server apparatus 14. Note that the program for implementing the print data acquisition unit 61 may be an application on an extended platform or a standard application that is installed on the image forming apparatus 13, for example. The print unit 62 prints the print data acquired by the print data acquisition unit 61. The program for implementing the print unit 62 may be a printer application, for example.

<<Print Server Apparatus>>

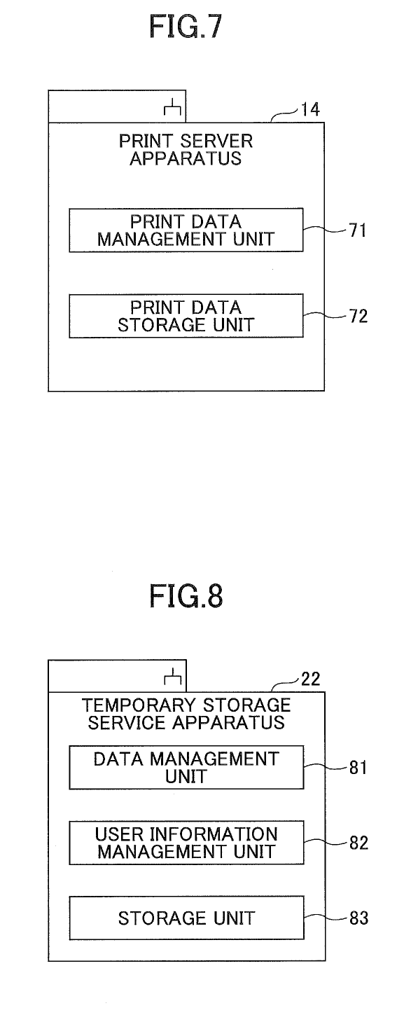

FIG. 7 is a block diagram illustrating an exemplary functional configuration of the print server apparatus 14. In FIG. 7, the print server apparatus 14 includes a print data management unit 71 and a print data storage unit 72 that are implemented by executing relevant programs.

The print data management unit 71 accepts a print data list acquisition request and a print data acquisition request from the image forming apparatus 13 and provides the requested print data list and the requested print data to the image forming apparatus 13. The print data storage unit 72 receives print data from the relay server apparatus 11 and stores the received print data in association with user information. The print data storage unit 72 may be implemented by a RDBMS (relational database management system) or a file system, for example.

<<Temporary Storage Service Apparatus>>

FIG. 8 is a block diagram illustrating an exemplary configuration of the temporary storage service apparatus 22. In FIG. 8, the temporary storage service apparatus 22 includes a data management unit 81, a user information management unit 82, and a storage unit 83 that are implemented by executing relevant programs.

The data management unit 81 provides print data that is stored in the storage unit 83 to the relay server apparatus 11 in response to a request from the relay server apparatus 11. The user information management unit 82 provides a list of user information of users that have stored print data in the storage unit 83 to the relay server apparatus 11 in response to a request from the relay server apparatus 11. The storage unit 83 stores print data transmitted from the terminal apparatus 31 in association with user information of the user that has stored the print data. The storage unit 83 may be implemented by a RDBMS or a file system, for example.

<<Terminal Apparatus>>

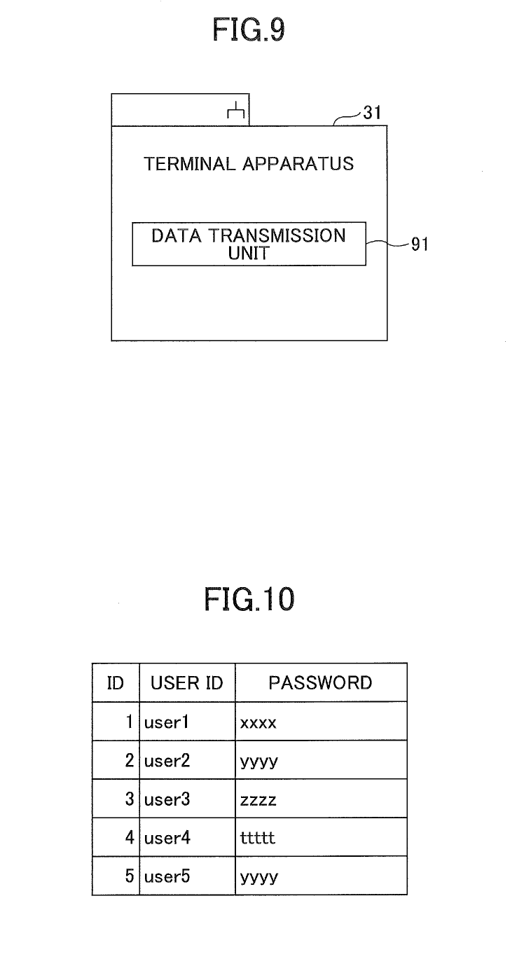

FIG. 9 is a block diagram illustrating an exemplary functional configuration of the terminal apparatus. In FIG. 9, the terminal apparatus 31 includes a data transmission unit 91 that is implemented by executing a relevant program. The data transmission unit 91 transmits print data to the temporary storage service apparatus 22. The data transmission unit 91 may establish communication with the temporary storage service apparatus 22 using a general communication protocol such as the HTTP/HTTPS. The data transmission unit 91 may transmit the print data via e-mail, for example.

<<Authentication Information>>

FIG. 10 is a table illustrating an exemplary configuration of authentication information. The authentication information of FIG. 10 is used by the authentication function of the authentication server apparatus 12. The authentication information of FIG. 10 includes a user ID and a password as items of information. The user ID and the password of the authentication information may be any information used to log into the on-premises system 10. For example, the user ID of the authentication information may be a user name. Also, note that the password does not necessarily have to be included.

<<Information Stored in Storage Unit of Temporary Storage Service Apparatus>>

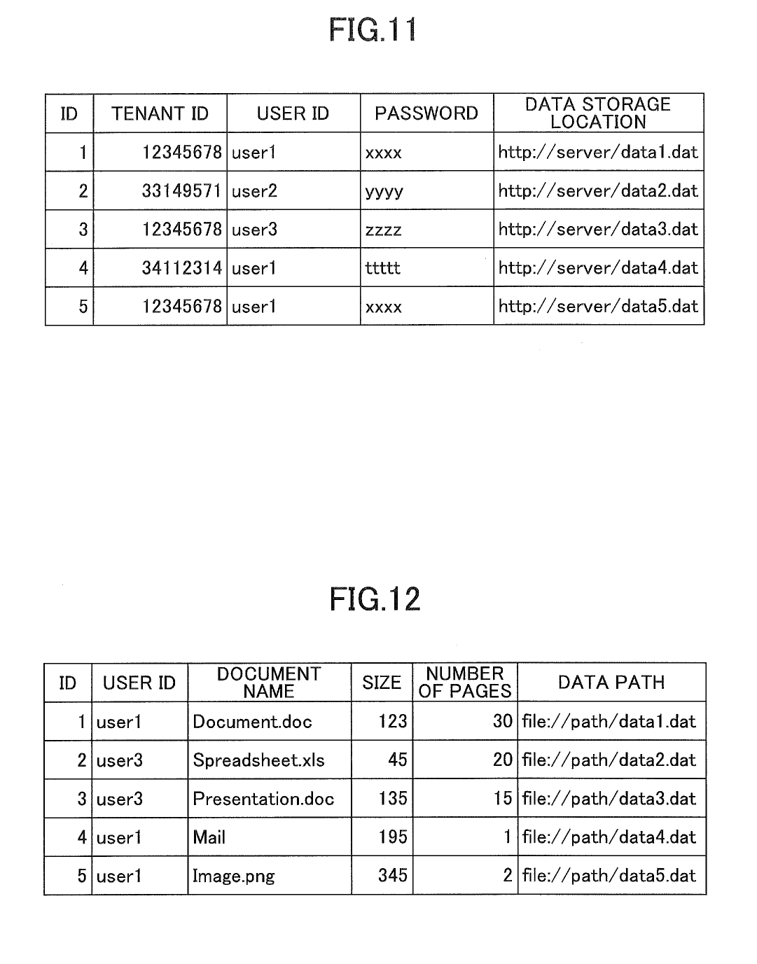

FIG. 11 is a table illustrating an exemplary configuration of information stored in the storage unit 83 of the temporary storage service apparatus 22. In the example of FIG. 11, the information stored in the storage unit 83 of the temporary storage service apparatus 22 includes a tenant ID, a user ID, a password, and a data storage location as items of information.

The tenant ID is information that uniquely identifies an organization such as a company or a department. The tenant ID is information for identifying a set of one or more users and/or devices (office equipment). The tenant ID is not limited by the literal sense of the word tenant and may be contract information identifying a contract with a set of users and/or devices, for example.

The user ID and the password are information used to log into the on-premises system 10. Note that although the user ID and the password managed under the same tenant ID have to be unique, there may be overlapping user IDs and passwords provided they are managed under different tenant IDs. The data storage location is an example of information indicating the storage location of print data Note the information stored in the storage unit 83 of the temporary storage service apparatus 22 as illustrated in FIG. 11 corresponds to a case where multiple tenants are managed, and as such, the tenant ID is included as an item of information. However, the tenant ID does not have to be included in a case where multiple tenants are not managed.

<<Information Stored in Print Data Storage Unit of Print Server Apparatus>>

Information as illustrated in FIG. 12 may be stored in the print data storage unit 72 of the print server apparatus 14, for example. FIG. 12 is a table illustrating an exemplary configuration of information stored in the print data storage unit 72 of the print server apparatus 14. Information stored in the print data storage unit 72 of the print server apparatus 14 includes a user ID, a document name, a size, a number of pages, and a data path as items of information.

The user ID is user identification information that identifies the user associated with print data. The document name is print data identification information for identifying print data. The size is the data size of print data. The number of pages is the number of pages of print data. The data path is an example of information indicating the storage location of print data.

<Process Operations>

In the following, process operations of the print system 1 according to the present embodiment are described in greater detail.

<<Overall Process Operations of Print System>>

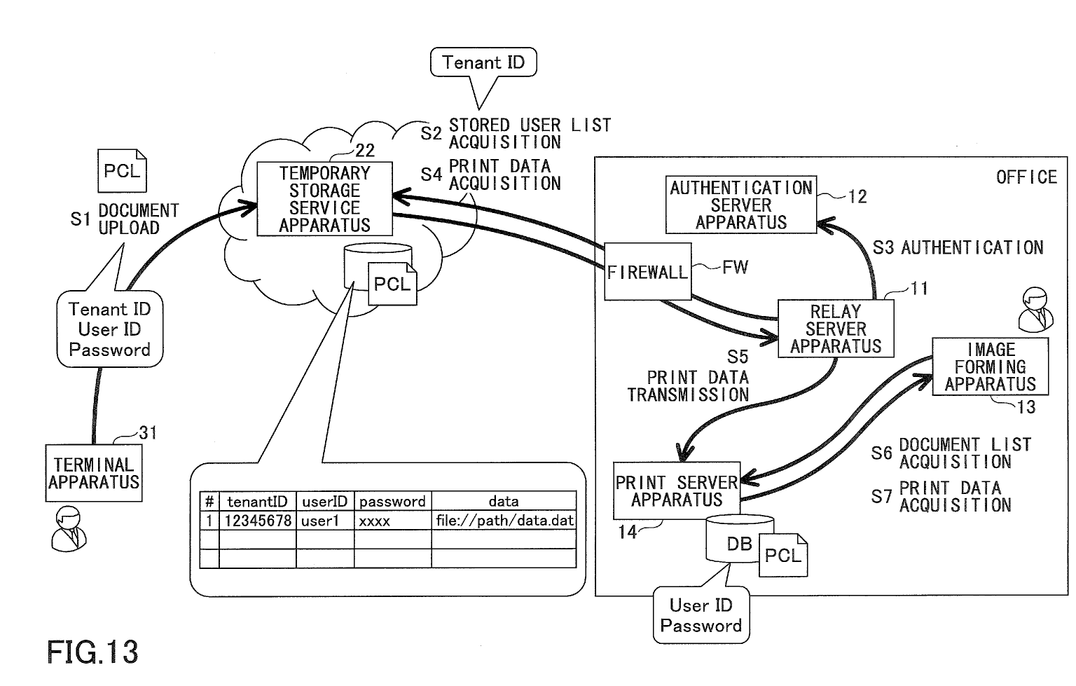

FIG. 13 schematically illustrates overall process operations of the print system 1 according to the first embodiment. In step S1, a user operates the terminal apparatus 31 and generates print data such as a document using an application installed in the terminal apparatus 31, for example. The terminal apparatus 30 may run a relevant application to generate PDF data or use a printer driver to generate PDL data, for example.

The terminal apparatus 31 makes a request to transmit (upload) print data to the temporary storage service apparatus 22. The terminal apparatus 31 transmits the print data such as a document together with a corresponding tenant ID, user ID and password to the temporary storage service apparatus 22.

In step S2, the relay server apparatus 11 acquires a list of user information of users that have stored print data in the temporary storage service apparatus 22 (stored user list) from the temporary storage service apparatus 22. Note that in a case where the temporary storage service apparatus 22 is used by users of a plurality of tenants, the relay server apparatus 11 may specify the tenant ID of the on-premises system 10 including the relay server apparatus 11 in order to acquire a list of user information of users of the specified on-premises system 10.

In step S3, the relay server apparatus 11 sends an authentication request to the authentication server apparatus 12 to authenticate the user information acquired in step S2. In step S4, the relay server apparatus 11 acquires from the temporary storage service apparatus 22 print data associated with the user information that has been successfully authenticated.

In step S5, the relay server apparatus 11 transmits the print data acquired from the temporary storage service apparatus 22 to the print server apparatus 14. The print server apparatus 14 stores the print data received from the relay server apparatus 11 in association with the corresponding user information.

In step S6, the user operates the image forming apparatus 13 and makes a display request for the print data list stored in the print server apparatus 14. The image forming apparatus 13 acquires the print data list (document list) from the print server 14 by specifying the user information. The user operates the image forming apparatus 13, and selects the print data to be printed from the print data list. In step S7, the image forming apparatus 13 acquires the print data selected by the user from the print server apparatus 14. The image forming apparatus 13 then prints the acquired print data.

In the print system 1 according to the present embodiment, authentication based on user information is not performed when transmitting print data from the terminal apparatus 31 to the temporary storage service apparatus 22 of the shared system 20, and instead, user information (pre-authentication information) to be used for authentication at the on-premises system 10 is attached to the print data that is transmitted to the temporary storage service apparatus 22. At the on-premises system 10, the relay server apparatus 11 may make an inquiry to the temporary storage service apparatus 22 about user information of users that have transmitted print data to the temporary storage service apparatus 22. Alternatively, the relay server apparatus 11 may receive notification from the temporary storage service apparatus 22 about user information of users that have transmitted print data to the temporary storage service apparatus 22, for example.

Upon acquiring user information from the temporary storage service apparatus 22, the relay server apparatus 11 uses the acquired user information to login (presence confirmation) via the authentication server apparatus 12. If login is successful, the relay server apparatus 11 acquires from the temporary storage services 22 print data associated with the user information used to successfully login and stores the acquired print data in the print server apparatus 14.

Thus, in the print system 1 according to the first embodiment, print data temporarily stored in the shared system 20 may be handled in a manner similar to print data handled by a pull print system of the on-premises system 10.

Also, in the print system 1 according to the first embodiment, authentication information used by the on-premises system 10 such as that illustrated in FIG. 10 does not have to be provided outside the on-premises system 10, and as such, information security may be maintained. Also, in the print system 1 according to the first embodiment, information such as a PIN code does not have to be entered at the time of printing print data, and in this way, user convenience may be improved.

<<Submission/Cooperation Process of Print System>>

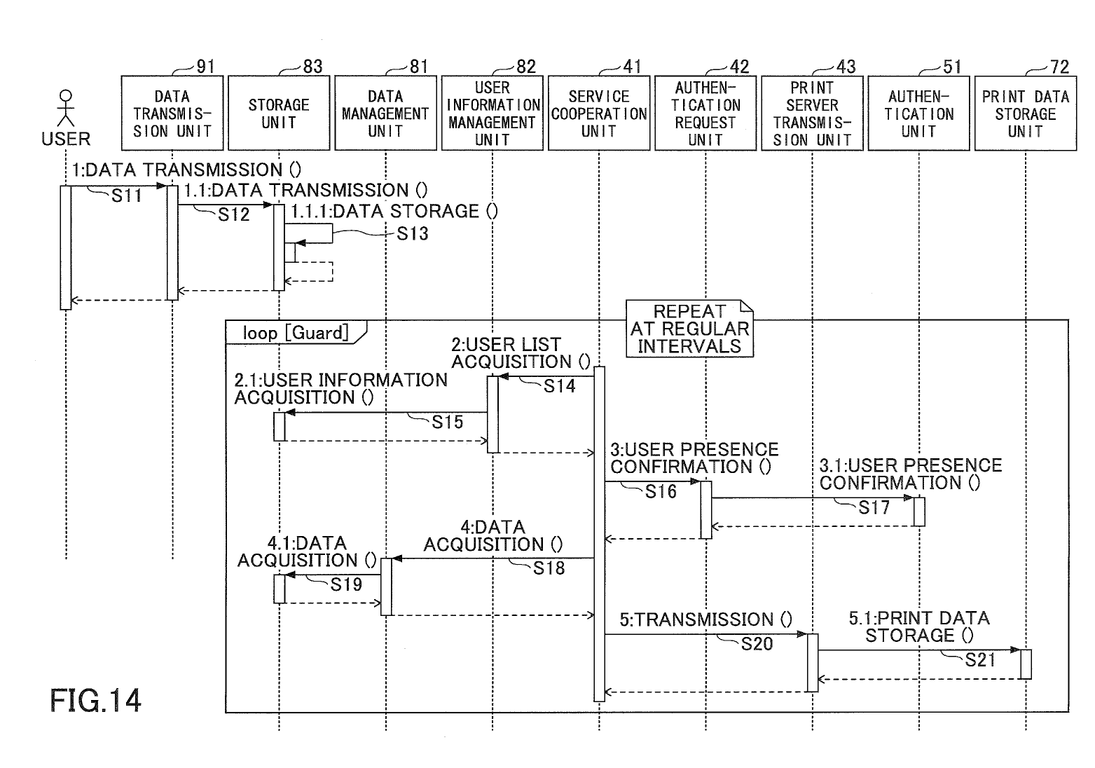

FIG. 14 is a sequence chart illustrating an exemplary submission/cooperation process of the print system according to the first embodiment. In step S11, a user operates the terminal apparatus 31 to make a request to have print data transmitted (uploaded) to the temporary storage service apparatus 22.

In step S12, the data transmission unit 91 of the terminal apparatus 31 associates the print data with user information (tenant ID, user ID, and password) of the user storing the print data, and transmits the print data and the associated user information to the temporary storage service apparatus 22 that is set up in advance.

Note that the print system 1 according to the first embodiment contemplates transmitting print data in a printable format (PDF, PDL, etc.) from the terminal apparatus 31. However, in some embodiments, data transmitted from the terminal apparatus 31 may be converted into a printable data format at the temporary storage service apparatus 22, for example. Also, in some embodiments, the user information may be embedded in the print data and extracted at the temporary storage service apparatus 22, for example.

In step S13, the storage unit 83 of the temporary storage service apparatus 22 stores the print data received from the terminal apparatus 31 in association with the user information associated with the print data. Note that steps S11 to S13 correspond to a submission process of the print system 1 according to the present embodiment.

The service cooperation unit 41 of the relay server apparatus 11 may be activated at regular intervals, for example, and in step S14, the service cooperation unit 41 transmits a user list acquisition request to the user information management unit 82 of the temporary storage service apparatus 22 to acquire a list of user information of users that have stored print data in the storage unit 83. In step S15, the user information management unit 82 acquires from the storage unit 83 the list of user information of the users that have stored print data in the storage unit 83, and provides the acquired user list to the service cooperation unit 41 of the relay server apparatus 11.

Then, the process proceeds to step S16 where the service cooperation unit 41 makes a request to the authentication request unit 42 to perform authentication (presence confirmation) with respect to the user information acquired from the temporary storage service apparatus 22. In step S17, the authentication request unit 42 makes a request to the authentication server apparatus 12 to perform authentication with respect to the user information acquired from the temporary storage service apparatus 22. In turn, the authentication unit 51 of the authentication server apparatus 12 uses the authentication information as illustrated in FIG. 10 to perform authentication with respect to the user information acquired from the temporary storage service apparatus 22, and returns the authentication result to the authentication request unit 42 of the relay server apparatus 11.

If the authentication result is successful, in step S18, the service cooperation unit 41 of the relay server apparatus 11 makes a data acquisition request to the data management unit 81 of the temporary storage service apparatus 22 to acquire print data associated with the user information that has been successfully authenticated. In step S19, the data management unit 81 acquires the print data associated with the user information that has been successfully authenticated from the storage unit 83, and provides the acquired print data to the service cooperation unit 41 of the relay server apparatus 11.

In step S20, the service cooperation unit 41 makes a request to the print server transmission unit 43 to transmit the print data and the user information acquired from the temporary storage service apparatus 22 to the print server apparatus 14. In step S21, the print server transmission unit 43 transmits the print data and the user information acquired from the temporary storage service apparatus 22 to the print server apparatus 14. The print data storage unit 72 of the print server apparatus 14 stores the print data and the user information received via the relay server apparatus 11 in association with each other. Note that steps S14 to S21 correspond to a cooperation process of the print system 1 according to the present embodiment.

<<Print Process of Print System>>

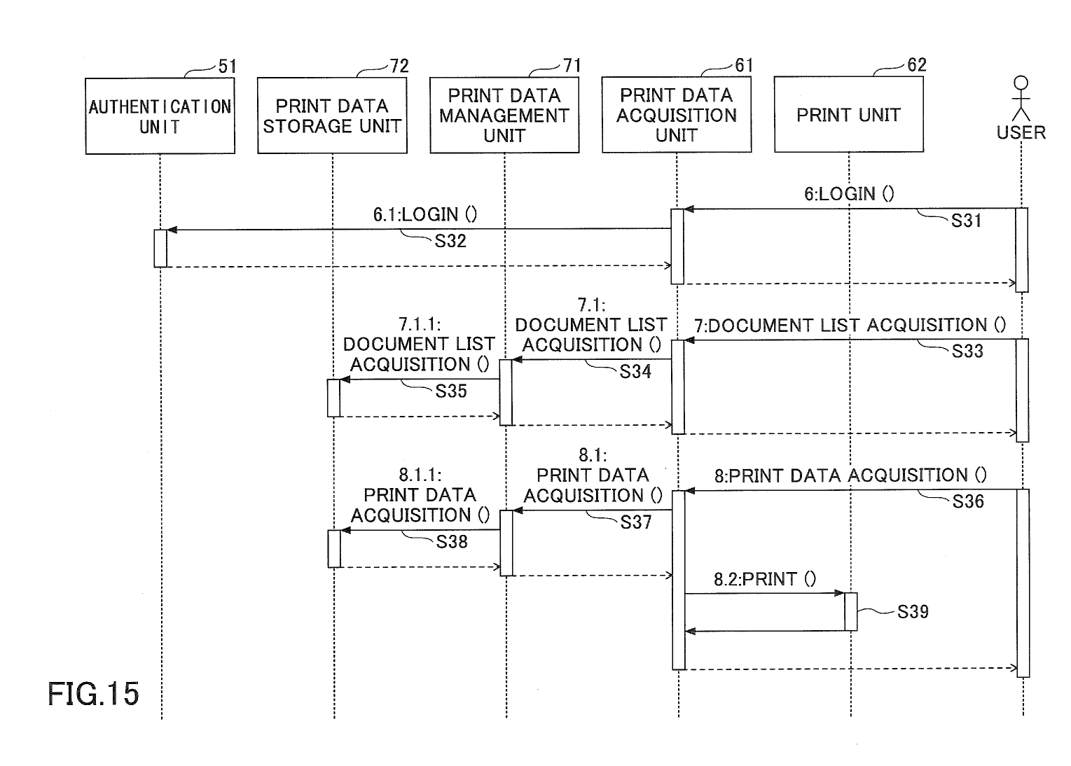

FIG. 15 is a sequence chart illustrating an exemplary print process of the print system 1 according to the first embodiment. In step S31, the user operates the image forming apparatus 13 to login using user information of the user. Note that login may be performed using an IC card or the like, for example.

In step S32, the print data acquisition unit 61 of the image forming apparatus 13 makes a login request to the authentication unit 51 of the authentication server apparatus 12 and receives the login result from the authentication unit 51. If the login result is successful, the user may proceed to step S33 and the subsequent process steps.

In step S33, the user operates the image forming apparatus 13 to request for the display of a list of print data stored in the print server apparatus 14. In step S34, the print data acquisition unit 61 of the image forming apparatus 13 sends a print data list (document list) acquisition request specifying the user information of the user to the print server apparatus 14.

In step S35, the print data management unit 71 of the print server apparatus 14 acquires the print data list from the print data storage unit 72, and provides the acquired print data list to the image forming apparatus 13. In turn, the print data acquisition unit 61 of the image forming apparatus 13 may display the print data list at the operation panel 602, for example.

In step S36, the user operates the image forming apparatus 13 to select the print data to be printed from the print data list. In step S37, the print data acquisition unit 61 of the image forming apparatus 13 sends a print data acquisition request to the print data management unit 71 of the print server apparatus 14 to acquire the print data selected by the user.

In step S38, the print data management unit 71 acquires the print data selected by the user from the print data storage unit 72, and provides the acquired print data to the image forming apparatus 13. In step S39, the print unit 62 of the image forming apparatus 13 prints the print data acquired by the print data acquisition unit 61 from the print server apparatus 14.

As described above, in the print system 1 according to the first embodiment in which the on-premises system 10 and the shared system 20 are arranged to cooperate with each other, authentication similar to that performed at the on-premises system 10 is not performed at the shared system 20. That is, in the print system 1 according to the first embodiment, authentication using user information is performed at the on-premises system 10 when print data is transmitted from the shared system 20 to the on-premises system 10.

Thus, in the print system 1 according to the first embodiment, management of authentication information for performing user authentication at the shared system 20 may be unnecessary, and as such, an increase in the user authentication management operation load may be prevented. Also, because information such as a PIN code does not have to be entered when printing print data, user convenience may be improved.

### Second Embodiment

In the following, the print system 1 according to a second embodiment of the present invention is described. In the print system 1 according to the second embodiment, a hash function is applied to the user information to be transmitted from the terminal apparatus 31 to the temporary storage service apparatus 22. Note that descriptions of features of the print system 1 according to the second embodiment that are substantially identical to those of the print system 1 according to the first embodiment are omitted.

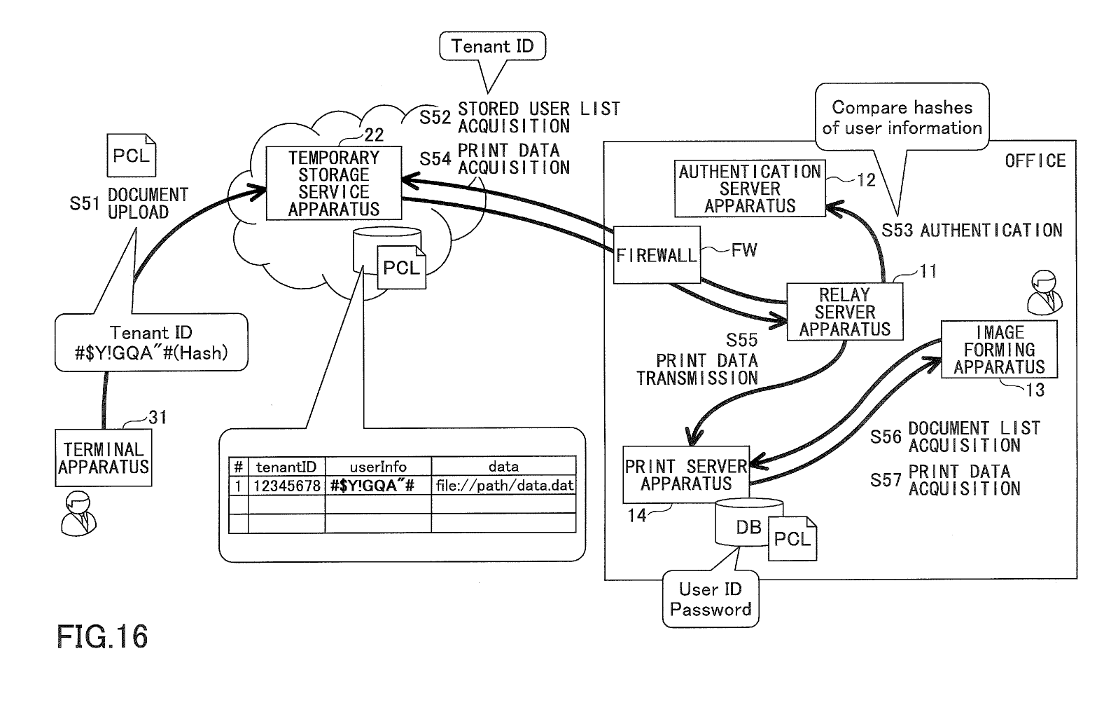

FIG. 16 schematically illustrates overall process operations of the print system 1 according to the second embodiment. In step S51, the user operates the terminal apparatus 31 to make a request to have print data such as a document transmitted (uploaded) to the temporary storage service apparatus 22. In turn, the terminal apparatus 31 transmits to the temporary storage service apparatus 22 the print data such as a document together with a corresponding tenant ID and a hash value (hash) of the user information obtained by applying a hash function to the user information.

Note that in some embodiments, the user information that is subjected to the hash function may only include a password. In other embodiments, the user information that is subjected to the hash function may include a user ID and a password. By applying a hash function to at least a part of the user information to be transmitted to the temporary storage service apparatus 22, the print system 1 according to the second embodiment may improve information security as compared to a case of transmitting and storing the user information as is in the temporary storage service apparatus 22.

In step S52, the relay server apparatus 11 acquires from the temporary storage service apparatus 22 a list including the hash value (hash) of the user information of the user that has stored print data in the temporary storage service apparatus 22 (stored user list).

In step S53, the relay server apparatus 11 sends a request to the authentication server apparatus 12 to perform authentication with respect to the hash of the user information included in the list acquired in step S52. The authentication server apparatus 12 obtains hashes of the authentication information as illustrated in FIG. 10 by applying the same hash function as that used to obtain the hash of the user information included in the list acquired by the relay server apparatus 11, and performs authentication by comparing the hash of the user information with the hashes of the authentication information.

In step S54, the relay server apparatus 11 acquires from the temporary storage service apparatus 22 the print data associated with the user information that has been successfully authenticated. In step S55, the relay server apparatus 11 transmits the print data acquired from the temporary storage service apparatus 22 to the print server apparatus 14. The print server apparatus 14 stores the print data received from the relay server apparatus 11 in association with the user information.

Note that step S56 and subsequent steps are the substantially identical to steps S6 and subsequent steps of the print system 1 according to the first embodiment, and as such, their descriptions are omitted. In the print system 1 according to the second embodiment, a process of applying a hash function to user information to be used for authentication at the on-premises system 10 is performed in addition to the process operations of the print system 1 according to the first embodiment. Thus, information security may be improved in the print system 1 according to the present embodiment as compared with the print system 1 according to the first embodiment.

### Third Embodiment

In the following, the print system 1 according to a third embodiment of the present invention is described. In the print system 1 according to the third embodiment, a temporary storage service apparatus 22A includes a conversion unit 84 that converts data other than print data such as application data into print data. Note that descriptions of features of the print system 1 according to the third embodiment that are substantially identical to those of the print system 1 according to the first embodiment are omitted.

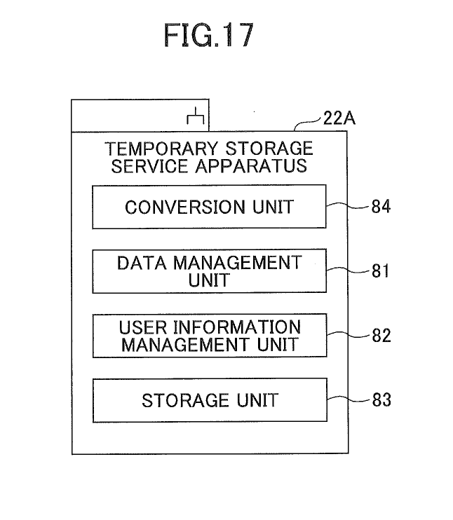

FIG. 17 is a block diagram illustrating an exemplary functional configuration of the temporary storage service apparatus 22A. In FIG. 17, the temporary storage service apparatus 22A includes the conversion unit 84 in addition to the elements of the temporary storage service apparatus 22 illustrated in FIG. 8. The conversion unit 84 converts data such as application data, text data, and image data into print data.

The storage unit 83 stores the print data converted by the conversion unit 84 in association with user information of the user storing the print data. That is, the temporary storage apparatus 22A converts data received from the terminal apparatus 31 into print data and then stores the resulting print data in the storage unit 83.

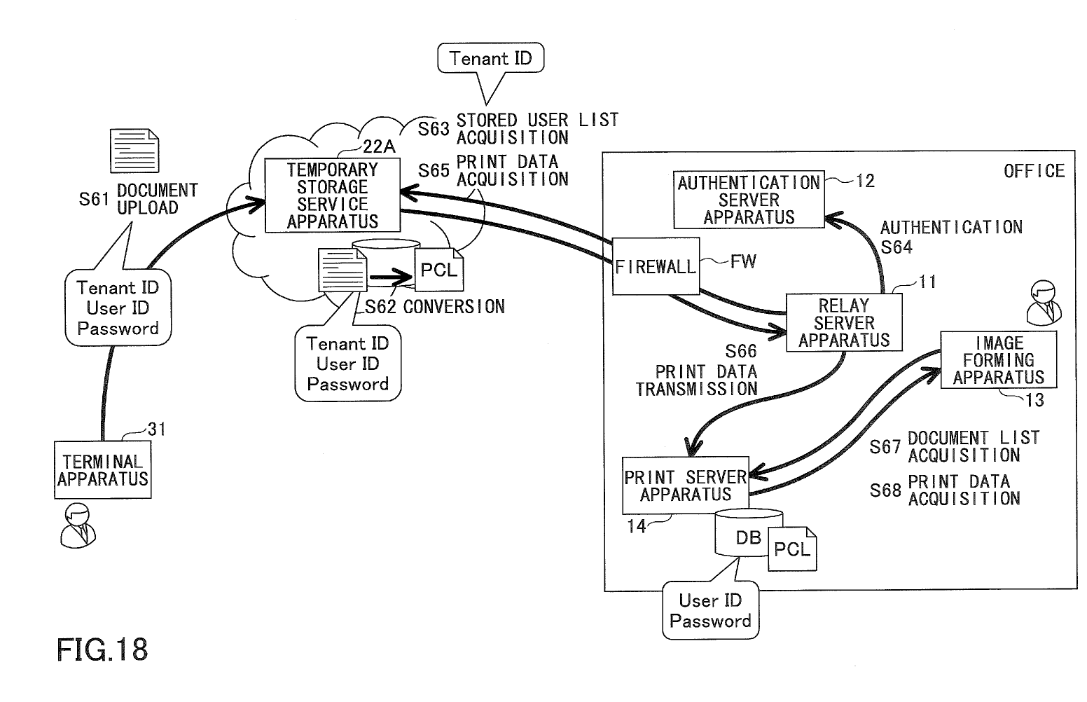

FIG. 18 schematically illustrates overall process operations of the print system according to the third embodiment. In step S61 the user operates the terminal apparatus 31 and makes a request to have data other than print data transmitted (uploaded) to the temporary storage service apparatus 22A. In turn, the terminal apparatus 31 transmits the data other print data together with a corresponding tenant ID, user ID, and password to the temporary storage service apparatus 22A.

In step S62, the conversion unit 84 of the temporary storage service apparatus 22A converts the data other than print data into print data. The storage unit 83 stores the print data converted by the conversion unit 84 in association with user information of the user storing the print data.

Note that step S63 and subsequent steps are substantially identical to step S2 and subsequent steps of the print system 1 according to the first embodiment, and as such, their descriptions are omitted.

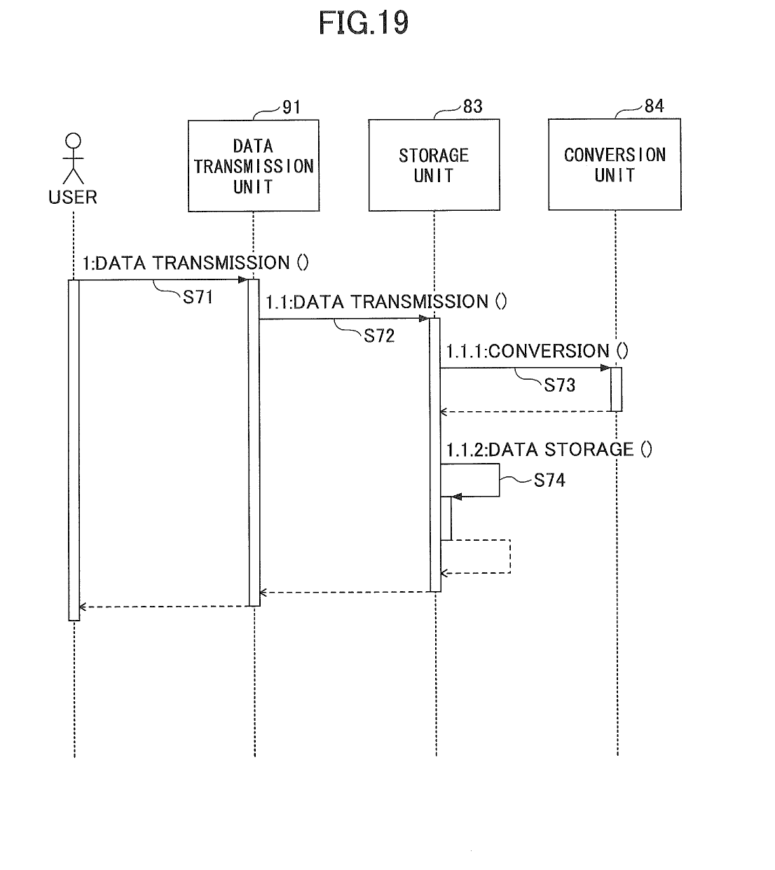

FIG. 19 is a sequence chart illustrating an exemplary submission process of the print system according to the third embodiment. In step S71, the user operates the terminal apparatus 31 and makes a request to have data other than print data transmitted (uploaded) to the temporary storage service apparatus 22A.

In step S72, the data transmission unit 91 of the terminal apparatus 31 associates the data other than print data with the user information of the user storing the data, and transmits the data other than print data together with the associated user information to the temporary storage service apparatus 22A that is set up in advance. Note that in some embodiments, the user information may be embedded in the data other than print data and extracted at the temporary storage service apparatus 22A, for example.

In step S73, the conversion unit 84 of the temporary storage service apparatus 22A converts the data other than print data received from the terminal apparatus 31 into print data. In step S74, the print data storage unit 83 of the temporary storage service apparatus 22A stores the print data converted by the conversion unit 84 in association with the user information of the user that has transmitted the print data.

As described above, in the print system 1 according to the third embodiment, a process of converting data into print data is performed at the temporary storage service apparatus 22A in addition to the process operations of the print system 1 according to the first embodiment. In the print system 1 according to the third embodiment, even when the terminal apparatus 31 does not have a print data conversion function, data may still be converted into print data and the resulting print data may be printed using the print system 1.

### Fourth Embodiment

In the following, the print system 1 according to a fourth embodiment of the present invention is described. The print system 1 according to the fourth embodiment differs from the print system 1 according to the third embodiment in that data other than print data such as application data is converted into print data at the time the relay server apparatus 11 is to acquire the print data from the temporary storage service apparatus 22A. Note that descriptions of features of the print system 1 according to the fourth embodiment that are substantially identical to those of the print system 1 according to the third embodiment are omitted.

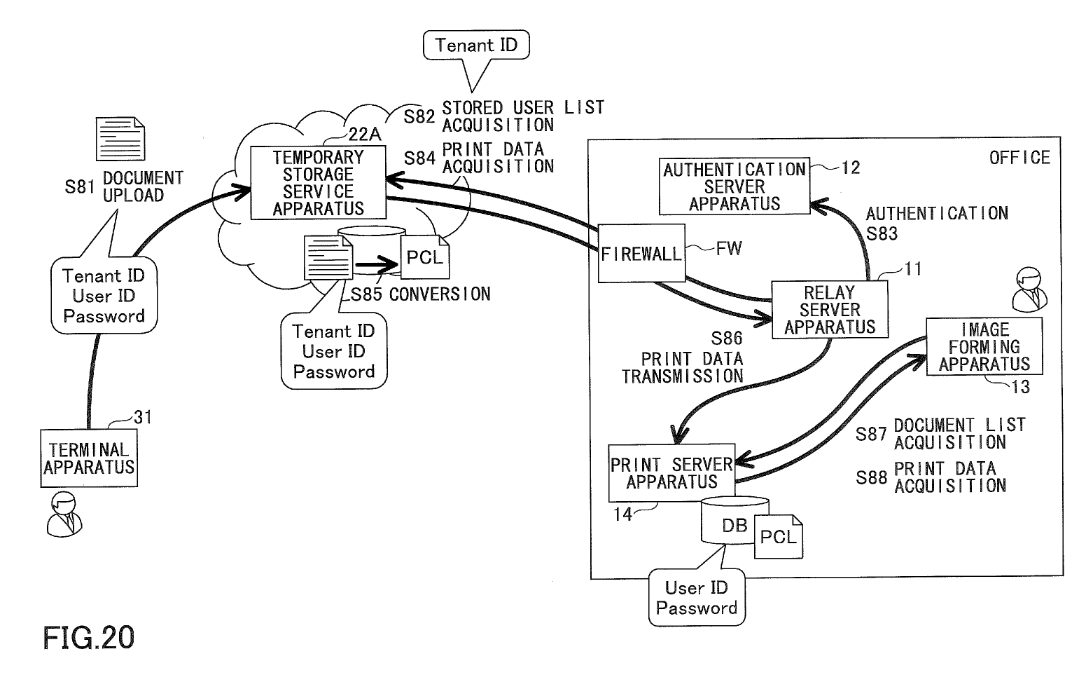

FIG. 20 schematically illustrates overall process operations of the print system according to the fourth embodiment. In step S81, the user operates the terminal apparatus 31 and makes a request to have data other than print data transmitted (uploaded) to the temporary storage service apparatus 22A. In turn, the terminal apparatus 31 transmits the data other than print data together with a corresponding tenant ID, user ID, and password to the temporary storage service apparatus 22A.

The storage unit 83 of the temporary storage service apparatus 22A stores the data other than print data in association with the user information of the user storing the data. That is, the temporary storage service apparatus 22A stores the data received from the terminal apparatus 31 in the storage unit 83 without converting the data into print data.

In step S82, the relay server apparatus 11 acquires from the temporary storage service apparatus 22A a list including the user information of the user that has stored data in the temporary storage service apparatus 22A.

In step S83, the relay server 11 makes an authentication request to the authentication server apparatus 12 to authenticate the user information included in the list acquired in step S82. In step S84, the relay server apparatus 11 makes an acquisition request to the temporary storage service apparatus 22A to acquire print data associated with the user information that has been successfully authenticated.

In step S85, the conversion unit 84 of the temporary storage service apparatus 22A converts data such as application data, text data, or image data into print data. The storage unit 83 provides the print data that has been converted by the conversion unit 84 to the relay server apparatus 11.

Note that step S86 and subsequent steps may be substantially identical to step S66 and subsequent steps of the print system 1 according to the third embodiment, and as such, their descriptions are omitted.

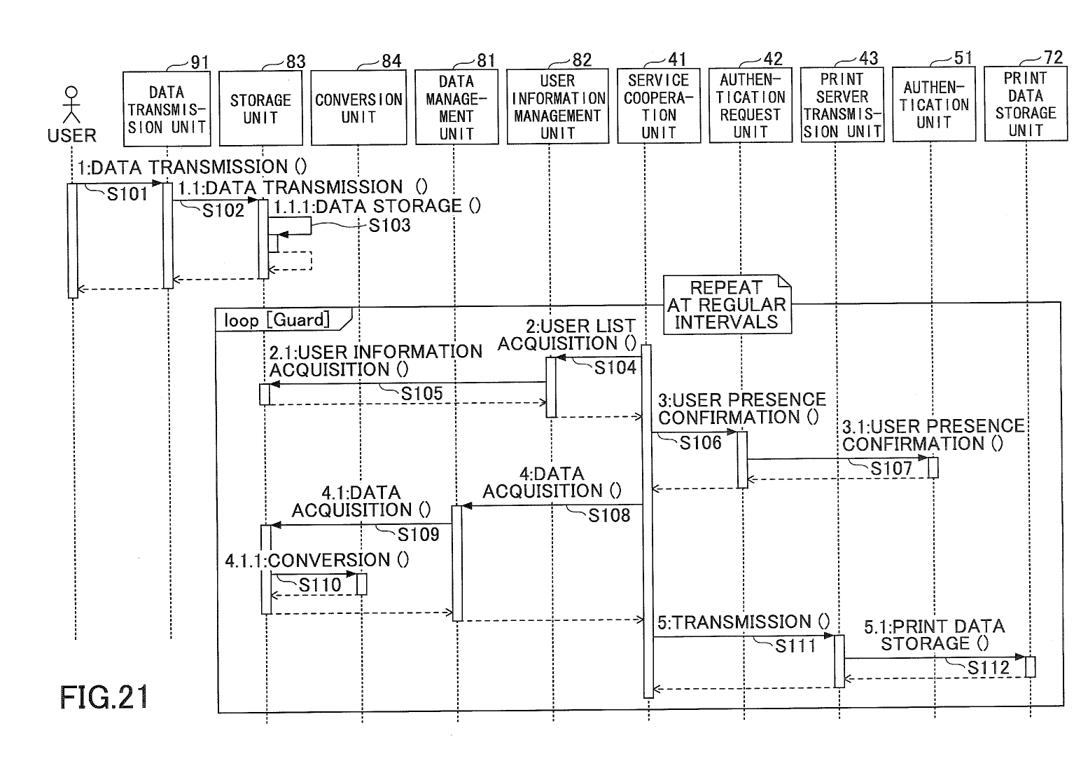

FIG. 21 is a sequence chart illustrating an exemplary submission/cooperation process of the print system according to the fourth embodiment. In step S101, the user operates the terminal apparatus 31 and makes a request to have data other than print data transmitted (uploaded) to the temporary storage service apparatus 22A. In step S102, the data transmission unit 91 of the terminal apparatus 31 associates the data other than print data with the user information of the user storing the data, and transmits the data other than print data together with the associated user information to the temporary storage service apparatus 22A that is set up in advance.

In step S103, the storage unit 83 of the temporary storage service apparatus 22A stores the data other than print data and the associated user information received from the terminal apparatus 31 in association with each other.

The service cooperation unit 41 of the relay server apparatus 11 may be activated at regular intervals, for example, and in step S104, the service cooperation unit 41 sends a user list acquisition request to the user information management unit 82 of the temporary storage service apparatus 22A to acquire a list including the user information of the user that has stored data other than print data in the storage unit 83.

In step S105, the user information management unit 82 acquires the list of user information from the storage unit 83, and provides the acquired list to the service cooperation unit 41 of the relay server apparatus 11. In steps S106 and S107 authentication of the user information acquired from the temporary storage service apparatus 22A is performed in a manner similar to steps S16 and S17 of FIG. 14.

If the authentication result is successful, in step S108, the service cooperation unit 41 of the relay server apparatus 11 sends a data acquisition request to the data management unit 81 of the temporary storage service apparatus 22A to acquire the data other than print data associated with the user information that has been successfully authenticated. In step S109, the data management unit 81 of the temporary storage service apparatus 22A makes a request to the conversion unit 84 to convert the data other than print data specified by the relay server apparatus 11 into print data.

In step S110, the conversion unit 84 of the temporary storage service apparatus 22A converts the data other than print data specified by the relay server apparatus 11 into print data. The data management unit 81 provides the resulting print data converted by the conversion unit 84 to the service cooperation unit 41 of the relay server apparatus 11.

Note that step S111 and subsequent steps may be substantially identical to step S20 and subsequent steps of the print system 1 according to the first embodiment, and as such, their descriptions are omitted.

As described above, in the print system 1 according to the fourth embodiment, the temporary storage service apparatus 22A converts data into print data at the time the relay server apparatus 11 is to acquire the print data from the temporary storage service apparatus 22A. That is, in the print system 1 according to the fourth embodiment, the temporary storage service apparatus 22A converts data that is associated with a user that has been successfully authenticated into print data, and as such, the operation load of the temporary storage service apparatus 22A may be reduced as compared with the print system 1 according to the third embodiment where the data is converted into print data at the time of storing the print data.

### Fifth Embodiment

In the following, the print system 1 according to a fifth embodiment of the present invention is described. In the print system according to the fifth embodiment 1, a temporary storage service apparatus 22B includes a user information history management unit 85 that manages user information of users that have acquired print data from the temporary storage service apparatus 22B as history information. If a current user is a user that has previously acquired print data from the temporary storage service apparatus 22B, the print system 1 according to the fifth embodiment converts data into print data at the same timing as the third embodiment. On the other hand, if a current user has never acquired print data from the temporary storage service apparatus 22B, the print system 1 according to the fifth embodiment converts data into print data at the same timing as the fourth embodiment. Note that descriptions of features of the print system 1 according to the fifth embodiment that are substantially identical to those of the print system 1 according to the third and/or fourth embodiments are omitted.

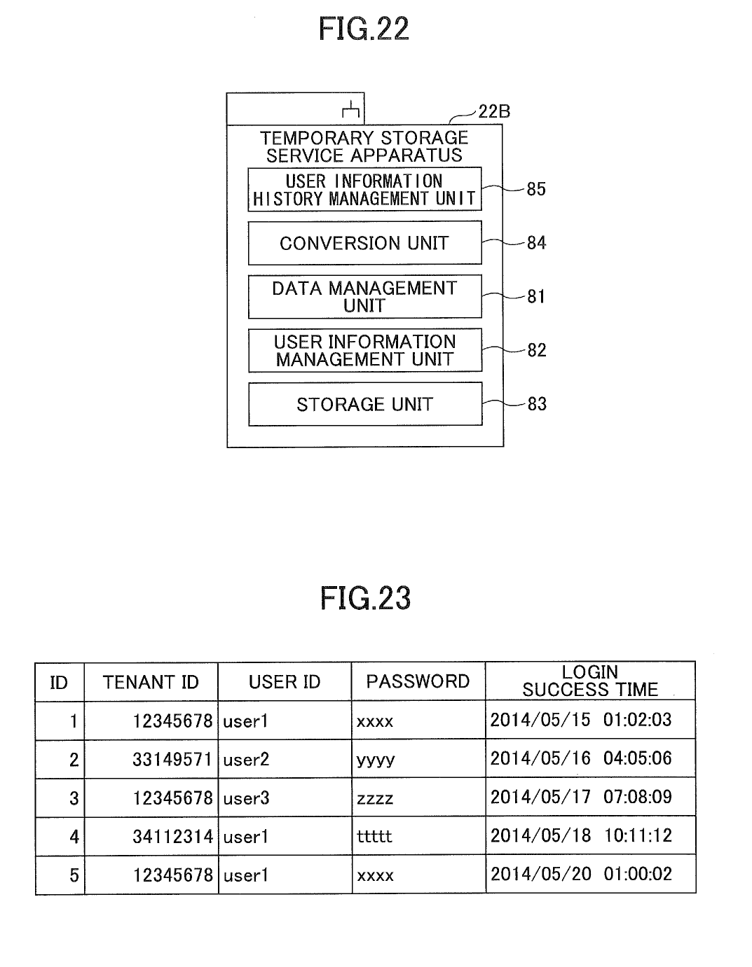

FIG. 22 is a block diagram illustrating an exemplary functional configuration of the temporary storage service apparatus 22B. In FIG. 22, the temporary storage service apparatus 22B includes the user information history management unit 85 in addition to the elements of the temporary storage service apparatus 22A of FIG. 17. The user information history management unit 85 manages a history of user information of users that have successfully been authenticated (presence confirmed) at the on-premises system 10 and have acquired print data from the temporary storage service apparatus 22B at the on-premises system 10. The user information history management unit 85 may delete the history after a predetermined time elapses, for example.

FIG. 23 is a table illustrating an exemplary configuration of information stored in the user information history management unit 85 of the temporary storage service apparatus 22B. In FIG. 23, the information (user information history) stored in the user information history management unit 85 of the temporary storage service apparatus 22B includes a tenant ID, a user ID, a password, and a login success time as items of information. The user information history management unit 85 accumulates and manages user information of a user that has been authenticated (presence confirmed) at the on-premises system 10 and has acquired print data from the temporary storage service apparatus 22B at the on-premises system 10 (i.e., a user that has provided print data to the on-premises system 10) as history information.

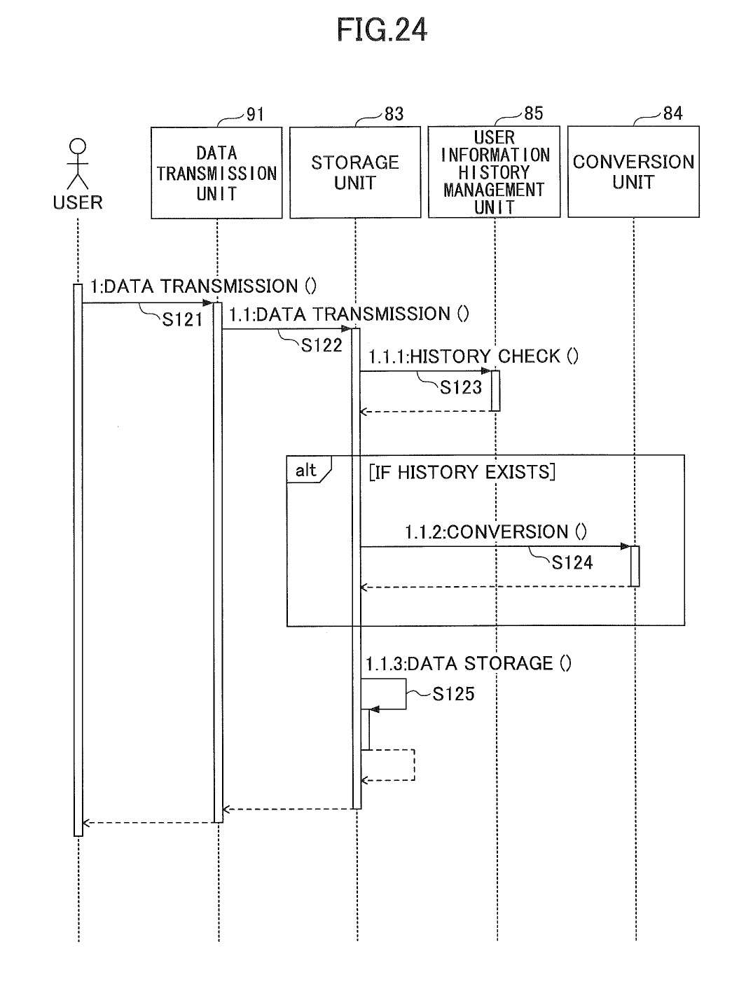

FIG. 24 is a sequence chart illustrating an exemplary submission process of the print system according to the fifth embodiment. In step S121, the user operates the terminal apparatus 31 and makes a request to have data other than print data transmitted (uploaded) to the temporary storage service apparatus 22B.

In step S122, the data transmission unit 91 of the terminal apparatus 31 associates the data other than print data with user information of the user storing the data, and transmits the data other than print data and the associated user information to the temporary storage service apparatus 22B that is set up in advance.

In step S123, the storage unit 83 makes an inquiry to the user information history management unit 85 to check whether the user information of the user storing the data other than print data is managed in the user information history as illustrated in FIG. 23. The user information history management unit 85 checks the user information history stored in the user information history management unit 85 of the temporary storage service apparatus 22B and returns the check result to the storage unit 83.

If the user information of the user storing the data other than print data is not managed in the user information history, the process proceeds to step S125 where the storage unit 83 stores the data received from the terminal apparatus 31 without converting the data into print data. If the user information of the user storing the data other than print data is managed in the user information history, the process proceeds to step S124 where the storage unit 83 requests the conversion unit 84 to convert the data other that print data into print data.

The conversion unit 84 converts the data other than print data received from the terminal apparatus 31 into print data. In step S125, the storage unit 83 of the temporary storage service apparatus 22B stores the resulting print data converted by the conversion unit 84 in association with the user information of the user storing the print data.

As described above, in the print system 1 according to the fifth embodiment, if a current user storing data is a user that has been successfully authenticated at the on-premises system 10 and has previously acquired print data from the temporary storage service apparatus 22B at the on-premises system 10, the data is converted into print data before being stored in the temporary storage service apparatus 22B.

In this way, the print system 1 according to the fifth embodiment may reduce the processing time required for the relay server apparatus 11 to acquire print data in a case where the current user is a user that has previously acquired print data from the temporary storage service apparatus 22B.

Also, in the print system 1 according to the fifth embodiment, if a current user storing data is a user that has never acquired print data from the temporary storage service apparatus 22B, the data is converted into print data at the time the relay server apparatus 11 is to acquire the print data from the temporary storage service apparatus 22B. That is, with respect to a user that has never acquired print data from the temporary storage service apparatus 22B, the print system 1 according to the fifth embodiment converts data stored by the user into print data after the user has been successfully authenticated at the on-premises system 10, and in this way, the operation load of the temporary storage service apparatus 22B may be reduced.

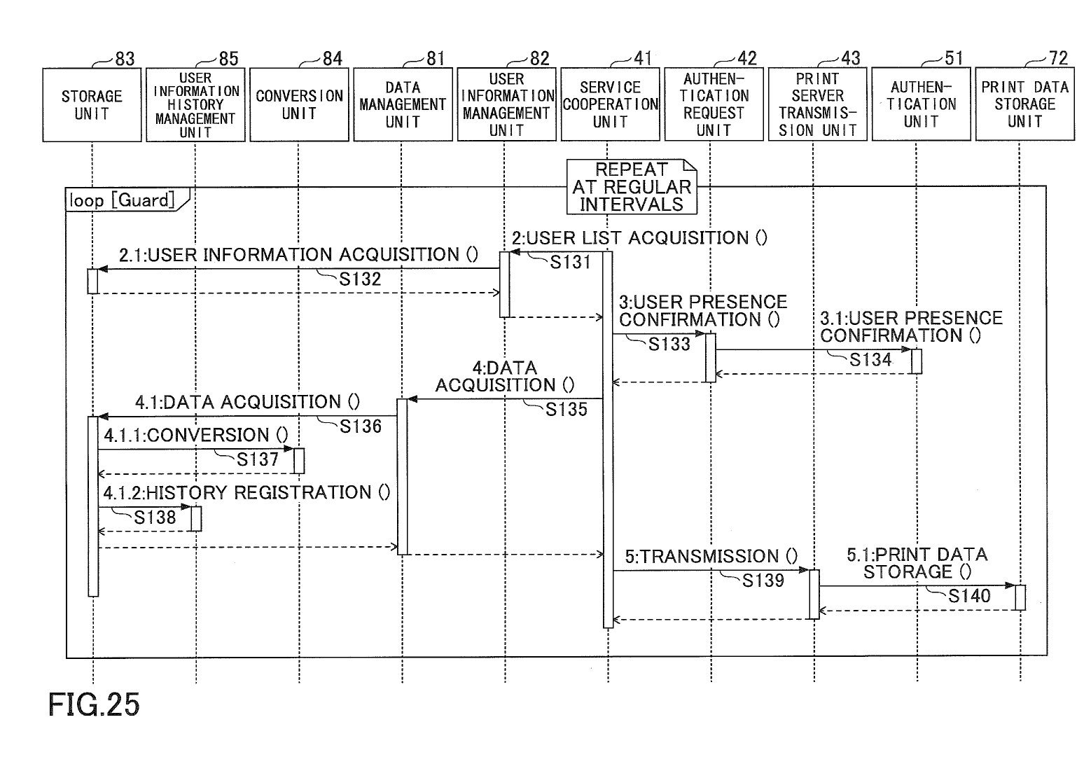

FIG. 25 is a sequence chart illustrating a cooperation process of the print system 1 according to the fifth embodiment. Note that the process steps of FIG. 25 are substantially identical to those of FIG. 21 except that step S138 corresponding to a process of registering user information history is added after step S137 corresponding to step S110 of FIG. 21.

In step S138, the storage unit 83 makes a history registration request to the user information history management unit 85. The user information history management unit 85 adds and manages user information of the user that has provided the data that has been converted into print data in step S137 as history information in the user information history as illustrated in FIG. 23. Note that step S139 and subsequent steps are substantially identical to step S111 and subsequent steps of FIG. 21, and as such, their descriptions are omitted.

As described above, the print system 1 according to the fifth embodiment is capable of adding and managing user information of users that have acquired print data from the temporary storage service apparatus 22B (i.e., users that have provided print data to the on-premises system 10) as history information.

### Sixth Embodiment

In the following, the print system 1 according to a sixth embodiment of the present invention is described. In the print system 1 according to the sixth embodiment, a temporary storage service apparatus 22C is configured to perform authentication using authentication information distinct from that used by the on-premises system 10. Note that descriptions of features of the print system 1 according to the sixth embodiment that are substantially identical to those of the print system 1 according to the first embodiment are omitted.

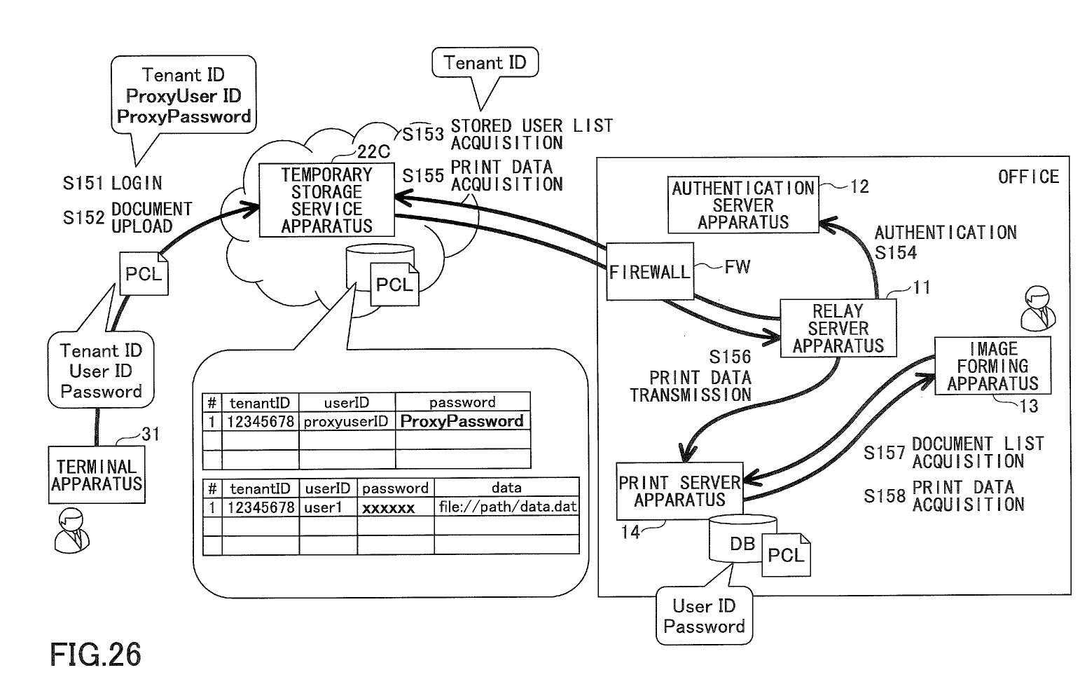

FIG. 26 schematically illustrates overall process operations of the print system according to the sixth embodiment. In step S151, the user operates the terminal apparatus 31 and logs into the temporary storage service apparatus 22C using authentication information for logging into the temporary storage service apparatus 22C (second authentication).

Note that management of the authentication information for logging into the temporary storage service apparatus 22C may be facilitated by using a common user ID (proxy user ID) and a common password (proxy password) for each tenant ID, for example.

After successfully logging into the temporary storage service apparatus 22C, in step S152, the user operates the terminal apparatus 31 and makes a request to have print data such as a document transmitted (uploaded) to the temporary storage service apparatus 22C. The terminal apparatus 31 transmits the print data such as a document together with authentication information to be used by the on-premises system 10 to the temporary storage service apparatus 22C.

In step S153, the relay server apparatus 11 uses the authentication information for logging into the temporary storage service apparatus 22C to log into the temporary storage service apparatus 22C at regular intervals. After successfully logging into the temporary storage service apparatus 22C, the relay server apparatus 11 acquires from the temporary storage service apparatus 22C a list including the user information of that user that has stored print data in the temporary storage service apparatus 22C. Note that step S154 and subsequent steps are substantially identical to step S3 and subsequent steps of FIG. 13, and as such, their descriptions are omitted.

In the print system 1 according to the sixth embodiment, authentication is performed at the temporary storage service apparatus 22C using authentication information that is distinct from the authentication information used by the on-premises system 10, and in this way, security against attack on the temporary storage service apparatus 22C may be improved.

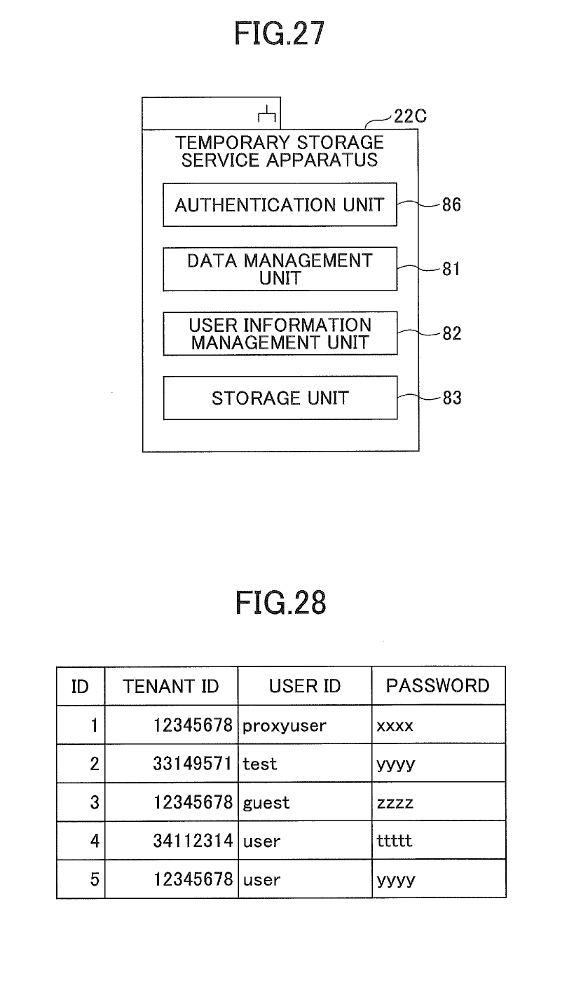

FIG. 27 is a block diagram illustrating an exemplary configuration of the temporary storage service apparatus 22C. The temporary storage service apparatus 22C illustrated in FIG. 27 includes an authentication unit 86 in addition to the elements of the temporary storage service apparatus 22 illustrated in FIG. 8. The authentication unit 86 performs authentication using the authentication information for logging into the temporary storage service apparatus 22C and manages users that are allowed to log into the temporary storage service apparatus 22C. The authentication unit 86 may use a common authentication system such as LDAP, for example. In some embodiments, the temporary storage service apparatus 22C may perform authentication in conjunction with another authentication server apparatus, for example.

FIG. 28 is a table illustrating an exemplary configuration of authentication information used by the authentication unit 86 of the temporary storage service apparatus 22C. The authentication information of FIG. 28 includes a tenant ID, a user ID, and a password as items of information. The user ID and the password of the authentication information of FIG. 28 may be any information used to log into the temporary storage service apparatus 22C. For example, the user ID of the authentication information of FIG. 28 may be a user name. Also, note that the password does not necessarily have to be included.

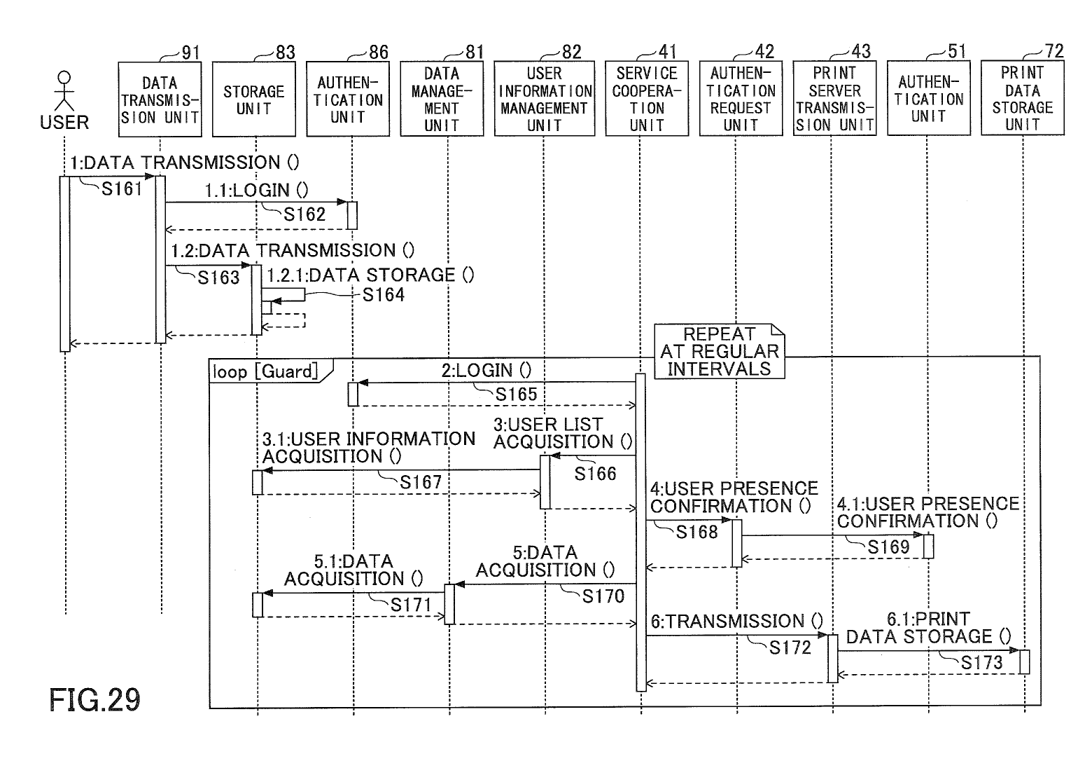

FIG. 29 is a sequence chart illustrating an exemplary submission/cooperation process of the print system according to the sixth embodiment.

In step S161, the user operates the terminal apparatus 31, enters authentication information for logging into the temporary storage service apparatus 22C and authentication information for logging into the on-premises system 10, and makes a request to have print data transmitted (uploaded) to the temporary storage service apparatus 22C.

In step S162, the data transmission unit 91 of the terminal apparatus 31 uses authentication information for logging into the temporary storage service apparatus 22C to log into the temporary storage service apparatus 22C. Upon successfully logging into the temporary storage service apparatus 22C, the data transmission unit 91 of the terminal apparatus 31 proceeds to step S163. In step S163, the data transmission unit 91 of the terminal apparatus 31 associates the print data with user information of the user storing the print data and transmits the print data together with the associated user information to the temporary storage service apparatus 22C that is set up in advance.

In step S164, the storage unit 83 of the temporary storage service apparatus 22C stores the print data received from the terminal apparatus 31 in association with the user information of the user that has transmitted the print data. Note that when the process of logging into the temporary storage service apparatus 22C ends in failure, the data transmission unit 91 of the terminal apparatus 31 does not perform the processes of steps S163 and S164.

The service cooperation unit 41 of the relay server apparatus 11 may be activated at regular intervals, for example, and in step S165, the service cooperation unit 41 logs into the temporary storage service apparatus 22C. Note that step S166 and subsequent steps are substantially identical to step S14 and subsequent steps of FIG. 14, and as such, their descriptions are omitted. As described above, in the print system 1 according to the sixth embodiment, authentication is performed at the temporary storage service apparatus 22C using authentication information that is distinct from the authentication information used by the on-premises system 10, and in this way, security against attacks on the temporary storage service apparatus 22C by unauthorized users may be improved, for example.

### Seventh Embodiment

In the following, the print system 1 according to a seventh embodiment of the present invention is described. In the print system 1 according to the seventh embodiment, a temporary storage service apparatus 22D is configured to perform authentication using a terminal ID of the terminal apparatus 31. Note that descriptions of features of the print system 1 according to the seventh embodiment that are substantially identical to those of the print system 1 according to the first embodiment are omitted.

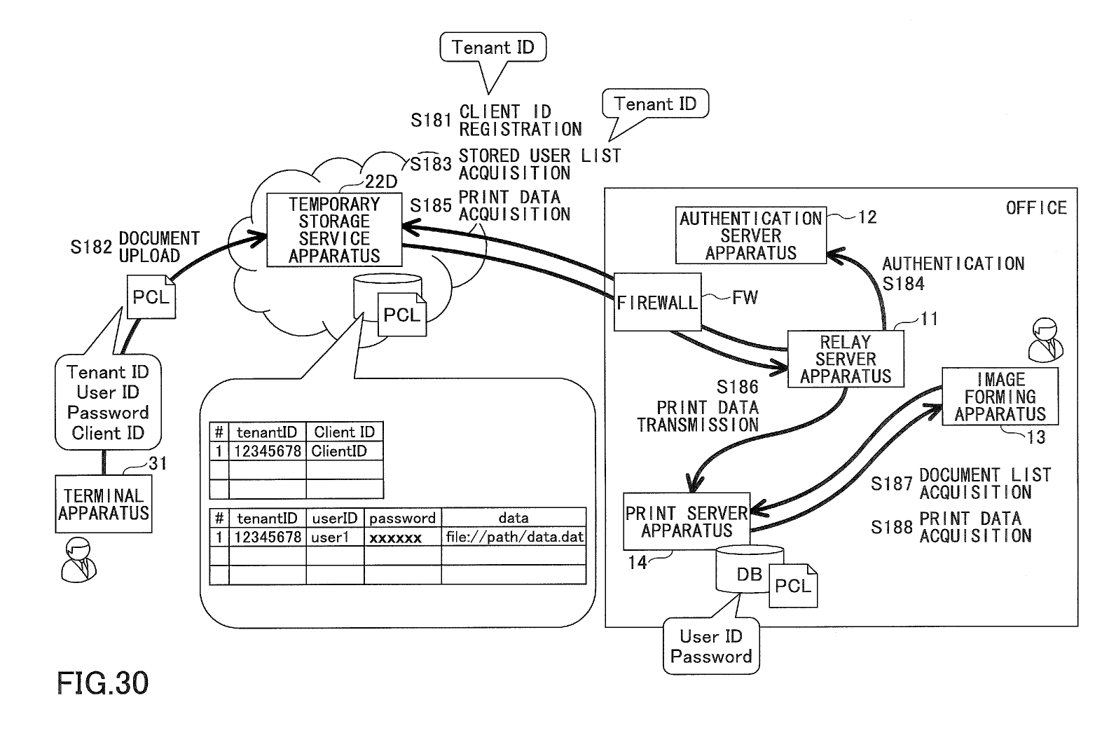

FIG. 30 schematically illustrates overall process operations of the print system 1 according to the seventh embodiment. In step S181, for example, an administrator of the print system 1 registers a terminal ID of the terminal apparatus 31 that is authorized to log into the temporary storage service apparatus 22D. The terminal ID is an example of information uniquely identifying the terminal apparatus 31.

In step S182, a user using the print system 1 operates the terminal apparatus 31 and makes a request to have print data such as a document transmitted (uploaded) to the temporary storage service apparatus 22D. In turn, the terminal apparatus 31 transmits the print data such as a document together with a corresponding tenant ID, user ID, password, and the terminal ID of the terminal apparatus 31 to the temporary storage service apparatus 22D.

The temporary storage service apparatus 22D confirms whether the terminal ID received from the terminal apparatus 31 is registered as a terminal ID of a terminal apparatus 31 that is authorized to log into the temporary storage service apparatus 22D.

If the terminal ID received from the terminal apparatus 31 is registered as a terminal ID of a terminal apparatus 31 that is authorized to log into the temporary storage service apparatus 22D, the temporary storage service apparatus 22D stores the received print data, tenant ID, user ID, and password in association with each other.

Note that if the terminal ID received from the terminal apparatus 31 is not registered as a terminal ID of a terminal apparatus 31 that is authorized to log into the temporary storage service apparatus 22D, the temporary storage service apparatus 22D does not store the received print data, terminal ID, user ID, and password. Note that step S183 and subsequent steps are substantially identical to step S2 and subsequent steps of FIG. 13, and as such, their descriptions are omitted.

In the print system 1 according to the seventh embodiment, authentication is performed by the temporary storage service apparatus 22D using the terminal ID of the terminal apparatus 31, and in this way, security against attacks on the temporary storage service apparatus 22D may be improved.

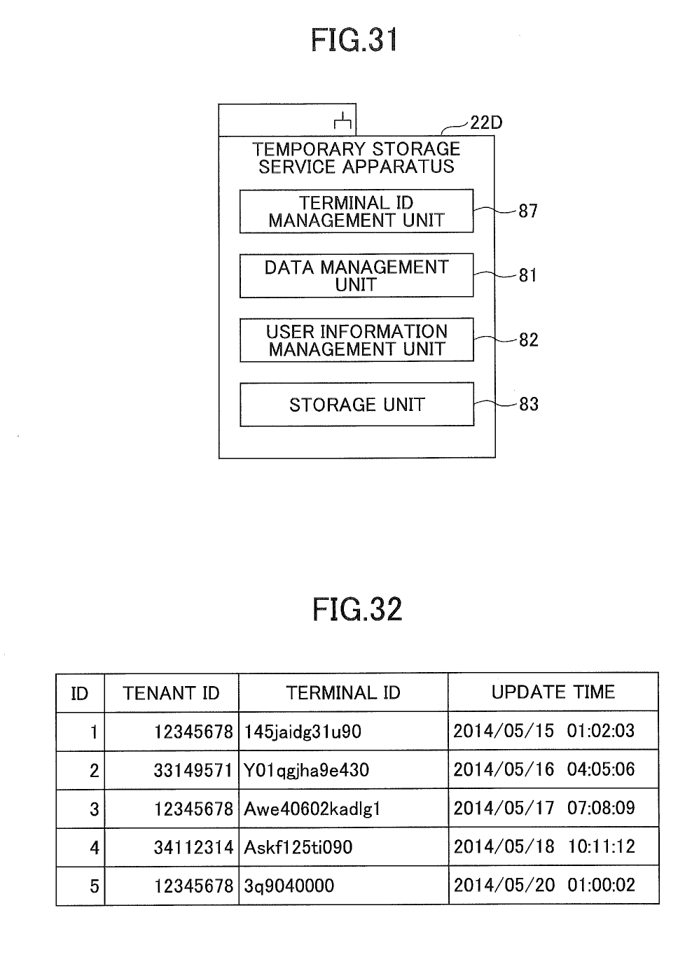

FIG. 31 is a block diagram illustrating an exemplary functional configuration of the temporary storage service apparatus 22D. The temporary storage service apparatus 22D illustrated in FIG. 31 includes a terminal ID management unit 87 in addition to the elements of the temporary storage service apparatus 22 illustrated in FIG. 8. The terminal ID management unit 87 accepts and manages a registration of a terminal ID of a terminal apparatus 31 that is authorized to log into the temporary storage service apparatus 22D from an administrator or the like.

FIG. 32 is a table illustrating an exemplary configuration of information managed by the terminal ID management unit 87 of the temporary storage service apparatus 22D.

The information managed by the terminal ID management unit 87 as illustrated in FIG. 32 includes a tenant ID, a terminal ID, and an update time as items of information. The terminal ID is information identifying the terminal apparatus 31 that is authorized to log into the temporary storage service apparatus 22D and corresponds to the terminal ID registered by the administrator in step S181.

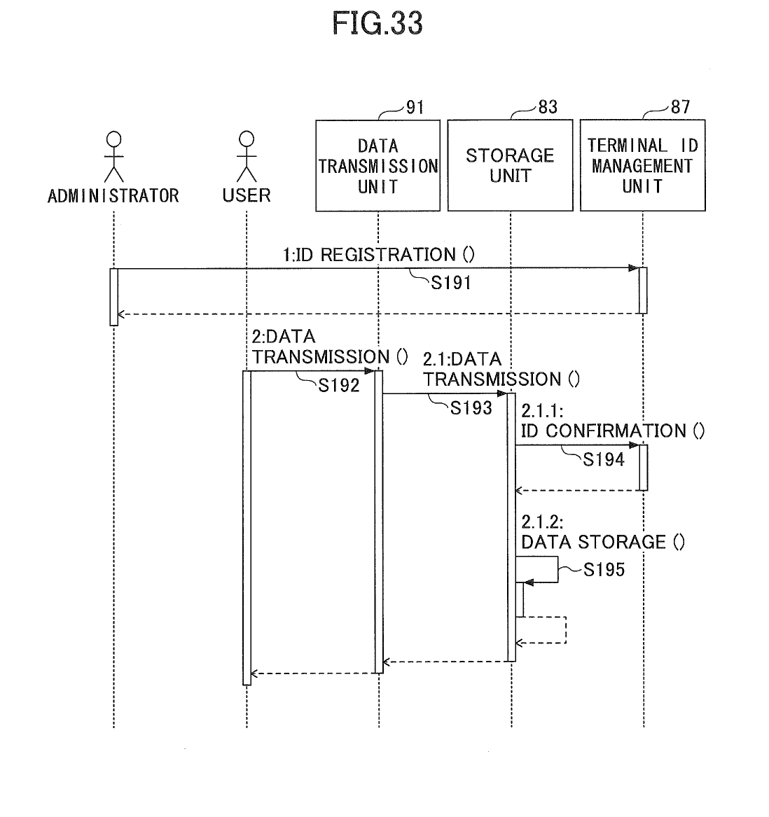

FIG. 33 is a sequence chart illustrating an exemplary submission process of the print system according to the seventh embodiment. In steps S191, for example, the administrator of the print system 1 registers the terminal ID of the terminal apparatus 31 that is authorized to log into the temporary storage service apparatus 22D. Note that registration of the terminal ID in step S191 may be performed using a web user interface (UI), for example.

In step S192, the user operates the terminal apparatus 31 and makes a request to have print data transmitted to the temporary storage service apparatus 22D. In step S193, the data transmission unit 91 of the terminal apparatus 31 transmits the print data together with the user information of the user storing the print data and the terminal ID of the terminal apparatus 31 to the temporary storage service apparatus 22D.

In step S194, the storage unit 83 confirms whether the terminal ID received from the terminal apparatus 31 is registered as a terminal ID of a terminal apparatus 31 that is authorized to log into the temporary storage service apparatus 22D by referring to the information of FIG. 32.

If the terminal ID received from the terminal apparatus 31 is registered as a terminal ID of a terminal apparatus 31 that is authorized to log into the temporary storage service apparatus 22D, the storage unit 83 proceeds to step S195. In step S195, the storage unit 83 stores the print data, the tenant ID, the user ID, and the password received from the terminal apparatus 31 in association with each other.

As described above, in the print system 1 according to the seventh embodiment, if the terminal ID of the terminal apparatus 31 being used to store print data is registered as a terminal ID of a terminal apparatus 31 that is authorized to log into the temporary storage service apparatus 22D, the print data may be registered (stored) in the temporary storage service apparatus 22D.

In the print system 1 according to the seventh embodiment, authentication is performed at the temporary storage service apparatus 22D using the terminal ID of the terminal apparatus 31 such that a user may not be required to enter authentication information (user information) for logging into the temporary storage service apparatus 22D when uploading print data, and in this way, security of the temporary storage service apparatus 22D may be improved without compromising user convenience, for example.

Note that in the print system 1 according to the seventh embodiment as described above, the tenant ID is transmitted from the terminal apparatus 31. However, in other embodiments, the temporary storage service apparatus 22D may include a table registering a terminal ID in association with a corresponding tenant ID such that transmission of the tenant ID may be unnecessary, for example.

### Eighth Embodiment

In the following, the print system 1 according to an eighth embodiment of the present invention is described. In the print system 1 according to the eighth embodiment, the terminal ID of the terminal apparatus 31 is used to perform authentication at the temporary storage service apparatus 22D and an authentication server apparatus 12A of the on-premises system 10. Note that descriptions of features of the print system 1 according to the eighth embodiment that are substantially identical to those of the print system 1 according to the first embodiment are omitted.

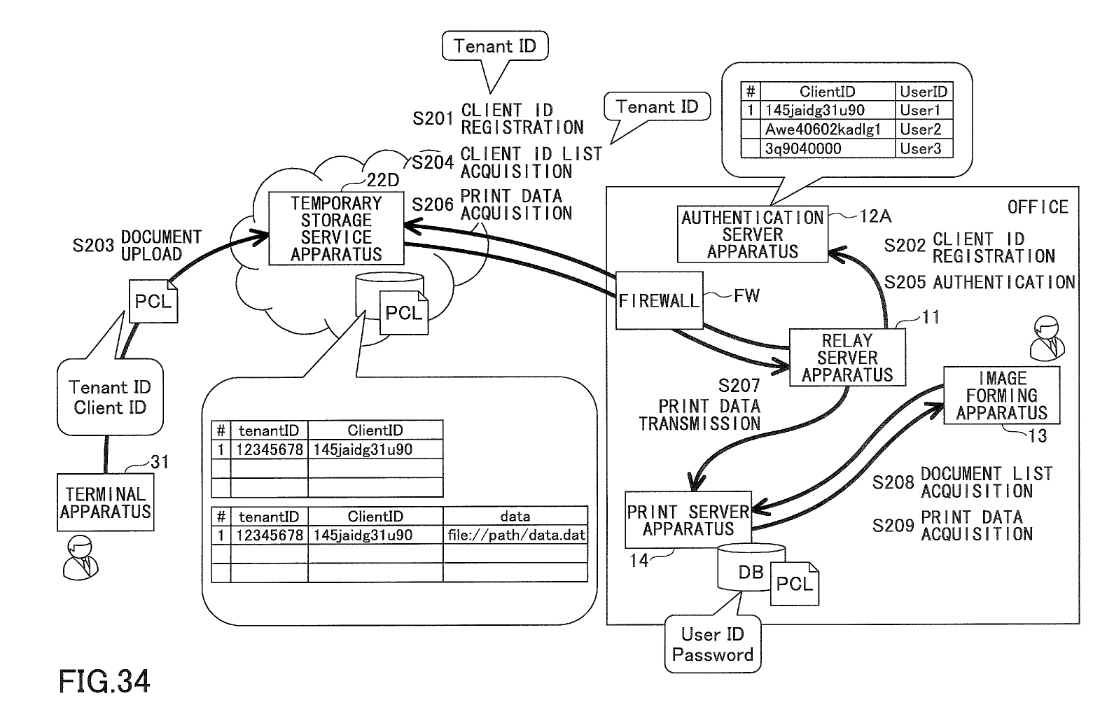

FIG. 34 schematically illustrates overall process operations of the print system according to the eighth embodiment. In step S201, for example, an administrator of the print system 1 registers the terminal ID of the terminal apparatus 31 that is authorized to log into the temporary storage service apparatus 22D. Also, in step S202, the administrator registers the terminal ID of the terminal apparatus 31 in association with user information in the authentication server apparatus 12A.

In step S203, when a user using the print system 1 operates the terminal apparatus 31 and makes a request to have print data transmitted (uploaded) to the temporary storage service apparatus 22D, the terminal apparatus 31 transmits the print data together with a corresponding tenant ID and the terminal ID of the terminal apparatus 31 to the temporary storage service apparatus 22D.

The temporary storage service apparatus 22D confirms whether the terminal ID received from the terminal apparatus 31 is registered as a terminal ID of a terminal apparatus 31 that is authorized to log into the temporary storage service apparatus 22D.

If the terminal ID received from the terminal apparatus 31 is registered as a terminal ID of a terminal apparatus 31 that is authorized to log into the temporary storage service apparatus 22D, the temporary storage service apparatus 22D stores the received print data received and the terminal ID of the terminal apparatus 31 in association with each other.

Note that if the terminal ID received from the terminal apparatus 31 is not registered as a terminal ID of a terminal apparatus 31 that is authorized to log into the temporary storage service apparatus 22D, the temporary storage service apparatus 22D does not store the received print data and the terminal ID of the terminal unit 31.

In step S204, the relay server apparatus 11 acquires from the temporary storage service apparatus 22D a terminal ID list (client ID list) including the terminal ID of the terminal apparatus 31 that has transmitted and stored print data in the temporary storage service apparatus 22D. In step S205, the relay server apparatus 11 makes an authentication request to the authentication server apparatus 12A to authenticate the terminal ID of the terminal apparatus 31 included in the terminal ID list acquired in step S204. In step S206, the relay server apparatus 11 acquires from the temporary storage service apparatus 22D print data associated with the terminal ID of the terminal apparatus 31 that has been successfully authenticated in step S206.

In step S207, the relay server apparatus 11 associates the print data acquired from the temporary storage service apparatus 22D with the user information registered in association with the terminal ID of the terminal apparatus 31, and transmits the print data together with the user information to the print server apparatus 14. The print server 14 stores the print data received from the relay server apparatus 11 in association with the user information. Note that step S208 and subsequent steps are substantially identical to step S6 and subsequent steps of FIG. 13, and as such, their descriptions are omitted.

In the print system 1 according to the eighth embodiment, the terminal ID of the terminal apparatus 31 is used to perform authentication at the temporary storage service apparatus 22D and the authentication server apparatus 12A, and in this way, security against attacks on the print system 1 may be improved, for example.

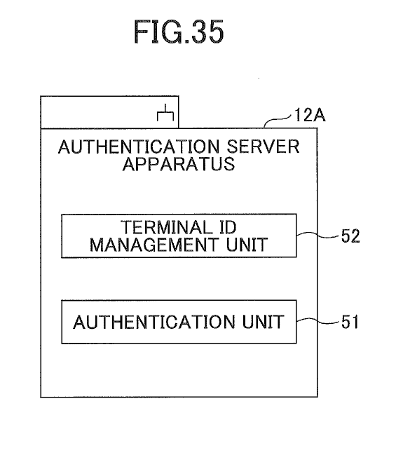

FIG. 35 is a block diagram illustrating an exemplary functional configuration of the authentication server apparatus 12A. In FIG. 35, the authentication server apparatus 12A includes a terminal ID management unit 52 in addition to the elements of the authentication server apparatus 12 illustrated in FIG. 5. The terminal ID management unit 52 registers and manages the terminal ID of the terminal apparatus 31 in association with user information.

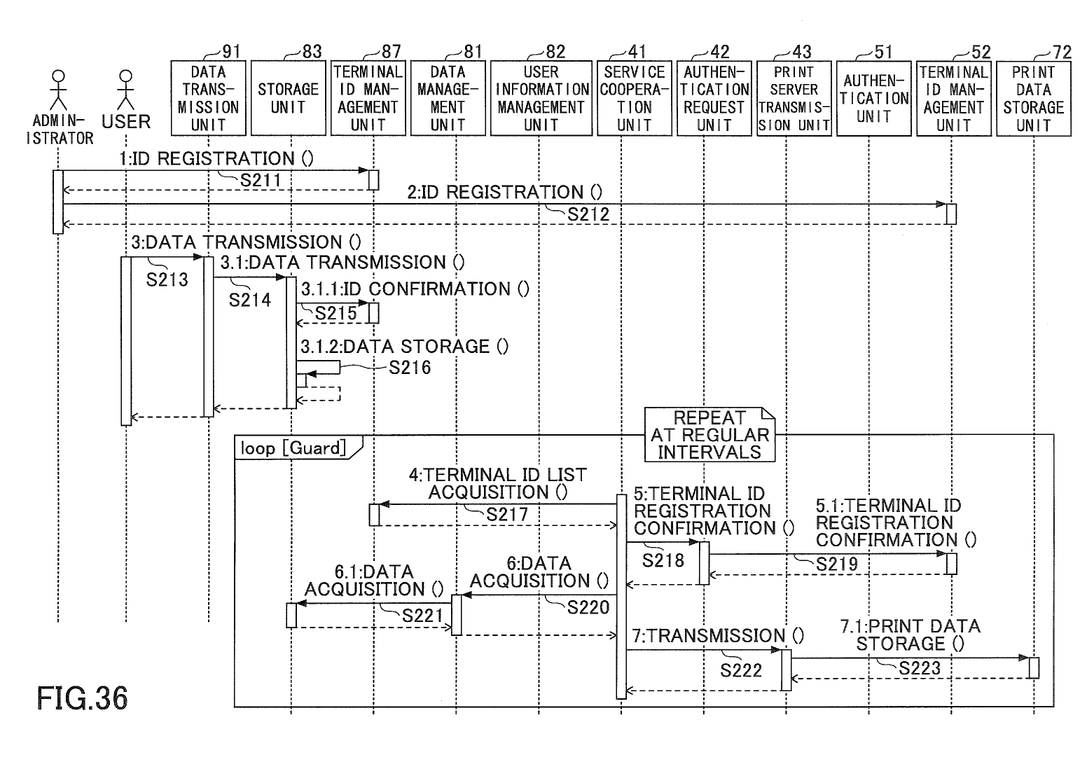

FIG. 36 is a sequence chart illustrating an exemplary submission/cooperation process of the print system according to the eighth embodiment. In step S211, for example, an administrator of the print system 1 registers a terminal ID of the terminal apparatus 31 that is authorized to log into the temporary storage service apparatus 22D in a manner similar to step S191 of FIG. 33. In step S212, the administrator of the print system 1 registers the terminal ID of the terminal apparatus 31 in association with user information in the terminal ID management unit 52 of the authentication server apparatus 12A. Note that the process of registering the terminal ID in step S212 may be performed using a web UI, for example.

In step S213, the user operates the terminal apparatus 31 and makes a request to have print data transmitted to the temporary storage service apparatus 22D. In step S214, the data transmission unit 91 of the terminal apparatus 31 transmits the print data together with a corresponding tenant ID and the terminal ID of the terminal apparatus 31 to the temporary storage service apparatus 22D.

In step S215, the storage unit 83 confirms whether the terminal ID received from the terminal apparatus 31 is registered as a terminal ID of a terminal apparatus 31 that is authorized to log into the temporary storage service apparatus 22D by referring to the information in FIG. 32.

If the terminal ID received from the terminal apparatus 31 is registered as a terminal ID of a terminal apparatus 31 that is authorized to log into the temporary storage service apparatus 22D, the storage unit 83 proceeds to step S216. In step S216, the storage unit 83 stores the print data received from the terminal apparatus 31 in association with the terminal ID of the terminal apparatus 31.

The service cooperation unit 41 of the relay server apparatus 11 may be activated at regular intervals, for example, and in step S217, the service cooperation unit 41 acquires from the terminal ID management unit 87 of the temporary storage service apparatus 22D a terminal ID list including the terminal ID of the terminal apparatus 31 that has transmitted and stored print data in the temporary storage service apparatus 22D.

In step S218, the service cooperation unit 41 makes a request to the authentication request unit 42 to authenticate the terminal ID of the terminal apparatus 31 included in the terminal ID list acquired in step S217. In step S219, the authentication request unit 42 makes a request to the terminal ID management unit 52 of the authentication server apparatus 12A to authenticate the terminal ID of the terminal apparatus 31 included in the terminal ID list. The terminal ID management unit 52 performs authentication with respect to the terminal ID of the terminal apparatus 31 included in the terminal ID list received from the authentication request unit 42 and confirms successful authentication of the terminal ID of the terminal apparatus 31 that is registered in association with user information.

In steps S220 and S221, the service cooperation unit 41 of the relay server apparatus 11 acquires from the temporary storage service apparatus 22D the print data associated with the terminal ID of the terminal apparatus 31 that has been successfully authenticated.

In steps S222 and S223, the service cooperation unit 41 of the relay server apparatus 11 associates the print data acquired from the temporary storage service apparatus 22D with the user information registered in association with the terminal ID of the terminal unit 31, and transmits the print data together with the user information to the print server apparatus 14. The print data storage unit 72 of the print server apparatus 14 stores the print data received from the relay server apparatus 11 in association with the user information.

As described above, in the print system 1 according to the eighth embodiment, the terminal ID of the terminal apparatus 31 is used to perform authentication at the temporary storage service apparatus 22D and the authentication server apparatus 12A, and in this way, security against attacks on the print system 1 may be further improved, for example.

### Ninth Embodiment

In the following, the print system 1 according to a ninth embodiment of the present invention is described. In the print system 1 according to the ninth embodiment, a token that is uniquely determined based on user information is used to perform authentication at an authentication server apparatus 12B of the on-premises system 10. Note that descriptions of features of the print system 1 according to the ninth embodiment that are substantially identical to those of the print system 1 according to the first embodiment are omitted.

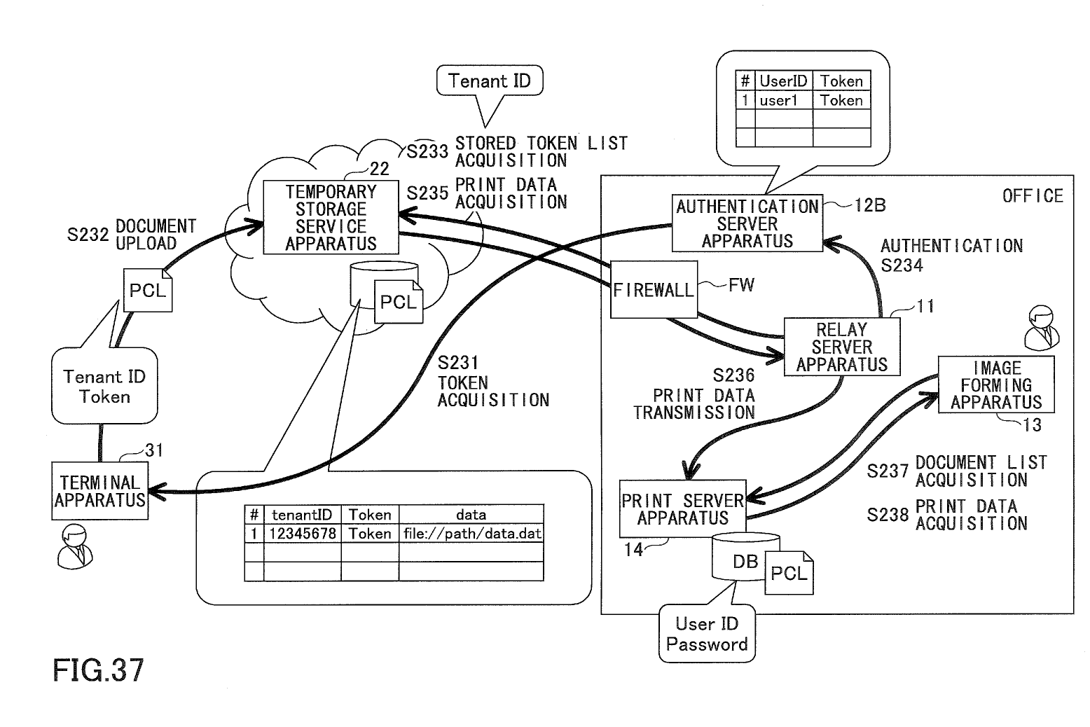

FIG. 37 schematically illustrates overall process operations of the print system according to the ninth embodiment. In step S231, a user makes a request to the authentication server apparatus 12B to generate a token, and acquires the generated token that is uniquely determined based on the user information of the user.

In step S232, when the user operates the terminal apparatus 31 to make a request to have print data transmitted (uploaded) to the temporary storage service apparatus 22, the terminal apparatus 31 transmits the print data together with the token acquired in step S231 to the temporary storage service apparatus 22. The temporary storage service apparatus 22 stores the received print data and the token in association with each other. In step S233, the relay server apparatus 11 acquires from the temporary storage service apparatus 22 a token list including the token associated with the print data stored in the temporary storage service apparatus 22.

In step S234, the relay server apparatus 11 makes a request to the authentication server apparatus 12B to authenticate the token included in the token list acquired in step S233. In step S235, the relay server apparatus 11 acquires from the temporary storage service apparatus 22 the print data associated with the token that has been successfully authenticated.

In step S236, the relay server apparatus 11 transmits the print data acquired from the temporary storage service apparatus 22 together with user information registered in association with the token to the print server apparatus 14. The print server apparatus 14 stores the print data received from the relay server apparatus 11 in association with the user information. Note that step S237 and subsequent steps are substantially identical to step S6 and subsequent steps of FIG. 13, and as such, their descriptions are omitted.

In the print system 1 according to the ninth embodiment, a token that is uniquely determined based on user information is used to perform authentication at the authentication server apparatus 12B, and in this way, the need to store user information in the temporary storage service apparatus 22 may be eliminated and information security may be improved, for example.

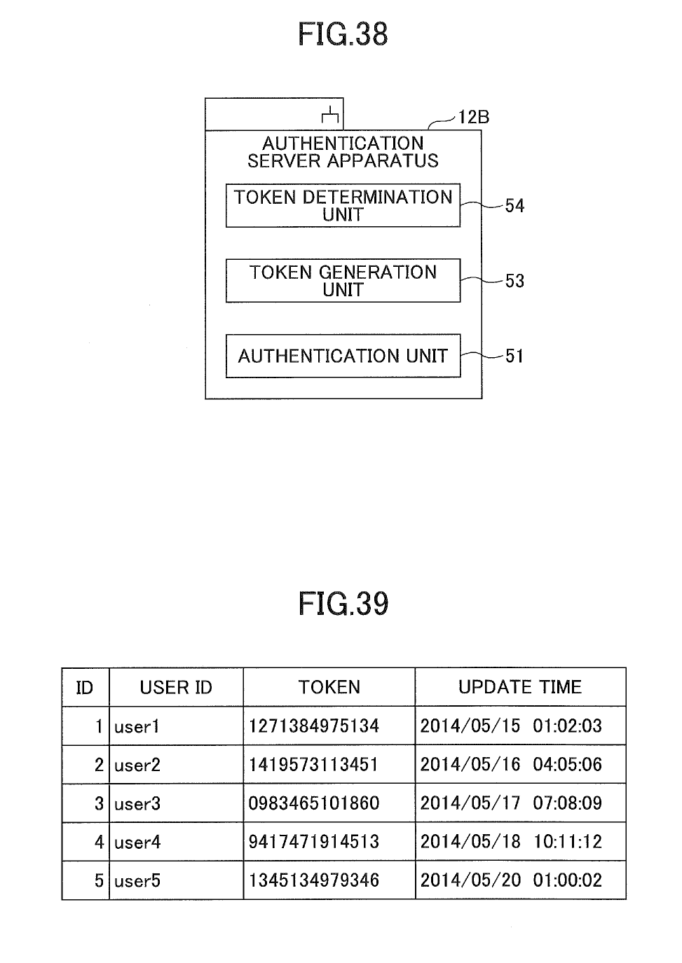

FIG. 38 is a block diagram illustrating an exemplary functional configuration of the authentication server apparatus 12B. The authentication server apparatus 12B of FIG. 38 includes a token generation unit 53 and a token determination unit 54 in addition to the elements of the authentication server apparatus 12 illustrated in FIG. 5.

The token generation unit 53 generates a token (random string) that is uniquely determined based on user information. The token determination unit 54 determines whether a token to be authenticated in response to a request from the relay server apparatus 11 matches a token generated by the token generation unit 53, and determines that authentication is successful if a match is found.

FIG. 39 is a table illustrating an exemplary configuration of information managed by the token generation unit 53 of the authentication server apparatus 12B. In FIG. 39, the information managed by the token generation unit 53 includes a user ID, a token, and an update time as items of information.

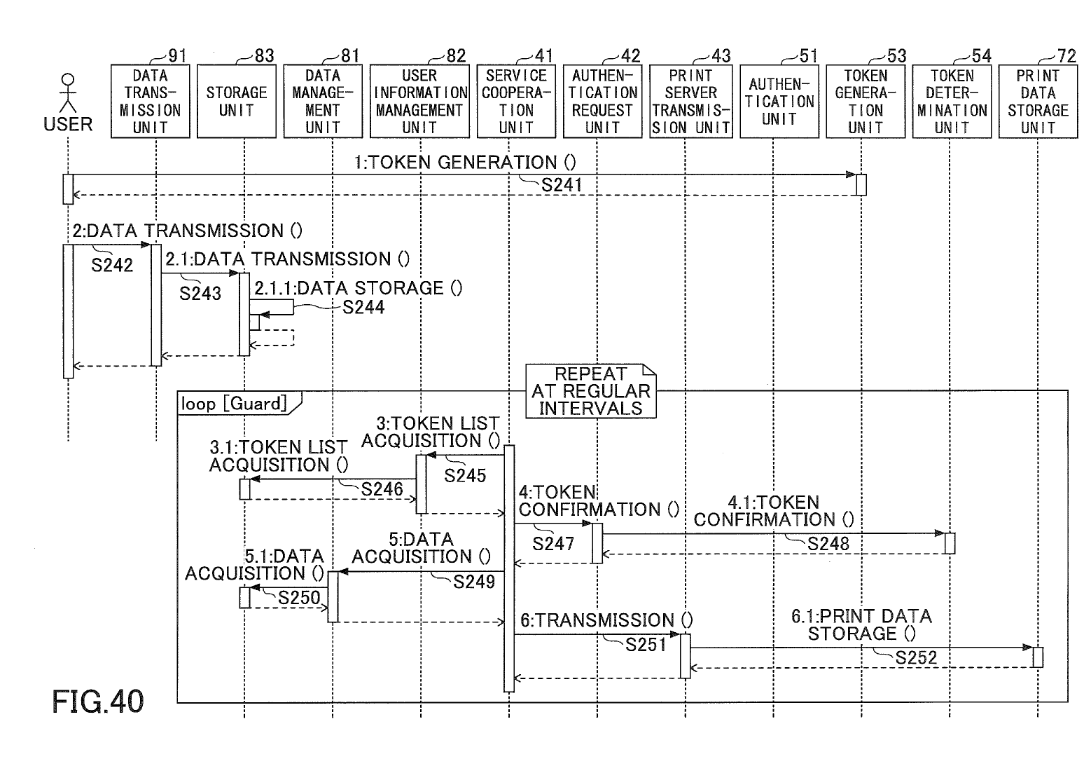

FIG. 40 is a sequence chart illustrating an exemplary submission/cooperation process of the print system 1 according to the ninth embodiment. In step S241, the user makes a request to the token generation unit 53 of the authentication server apparatus 12B to generate a token and acquires the generated token that is uniquely determined based on user information of the user. The token generation unit 53 of the authentication server apparatus 12B stores and manages the generated token in association with the user information that can be uniquely determined based on the token as illustrated in FIG. 39. Note that the process of generating a token in step S241 may be performed using a web UI, for example.

In step S242, the user operates the terminal apparatus 31 and makes a request to have print data transmitted to the temporary storage service apparatus 22. In step S243, the data transmission unit 91 of the terminal apparatus 31 transmits the print data together with the token acquired in step S241 to the temporary storage service apparatus 22. In step S244, the storage unit 83 stores the print data and the token received in step S243 in association with each other.

The service cooperation unit 41 of the relay server apparatus 11 may be activated at regular intervals, for example, and in step S245, the service cooperation unit 41 makes an acquisition request to the user information management unit 82 of the temporary storage service apparatus 22 to acquire a token list. In step S246, the user information management unit 82 acquires from the storage unit 83 the corresponding token list including the token associated with the print data stored in the storage unit 83, and provides the acquired token list to the service cooperation unit 41 of the relay server apparatus 11.

In step S247, the service cooperation unit 41 makes a request to the authentication request unit 42 to authenticate the token included in the token list. In step S248, the authentication request unit 42 makes a request to the token determination unit 54 of the authentication server apparatus 12B to authenticate the token include in the token list acquired from the temporary storage service apparatus 22.

The token determination unit 54 determines whether the token to be authenticated in response to the request from the relay server apparatus 11 matches a token generated by the token generation unit 53 using the information of FIG. 39 and confirms successful authentication if a match is found. In steps S249 and S250, the service cooperation unit 41 of the relay server apparatus 11 acquires from the temporary storage service apparatus 22 the print data associated with the token that has been successfully authenticated.

In steps S251 and S252, the service cooperation unit 41 of the relay server apparatus 11 associates the print data acquired from the temporary storage service apparatus 22 with the user information registered in association with the token, and transmits the print data together with the user information to the print server apparatus 14. The print data storage unit 72 of the print server apparatus 14 stores the print data received from the relay server apparatus 11 in association with the user information.

As described above, in the print system 1 according to the ninth embodiment, a token is transmitted to the temporary storage service apparatus 22 instead of user information, and in this way, information security may be improved, for example. Also, in the print system 1 according to the ninth embodiment, a unique token may be issued for each user to thereby accommodate cases where the terminal apparatus 31 is shared by a plurality of users, for example.

### Tenth Embodiment

In the following, the print system 1 according to a tenth embodiment of the present invention is described. In the print system 1 according to the tenth embodiment, a token is used to perform authentication at the authentication server apparatus 12B, and the token is also used as an encryption key to encrypt print data. Note that descriptions of features of the print system 1 according to the tenth embodiment that are substantially identical to the print system 1 according to the ninth embodiment are omitted.

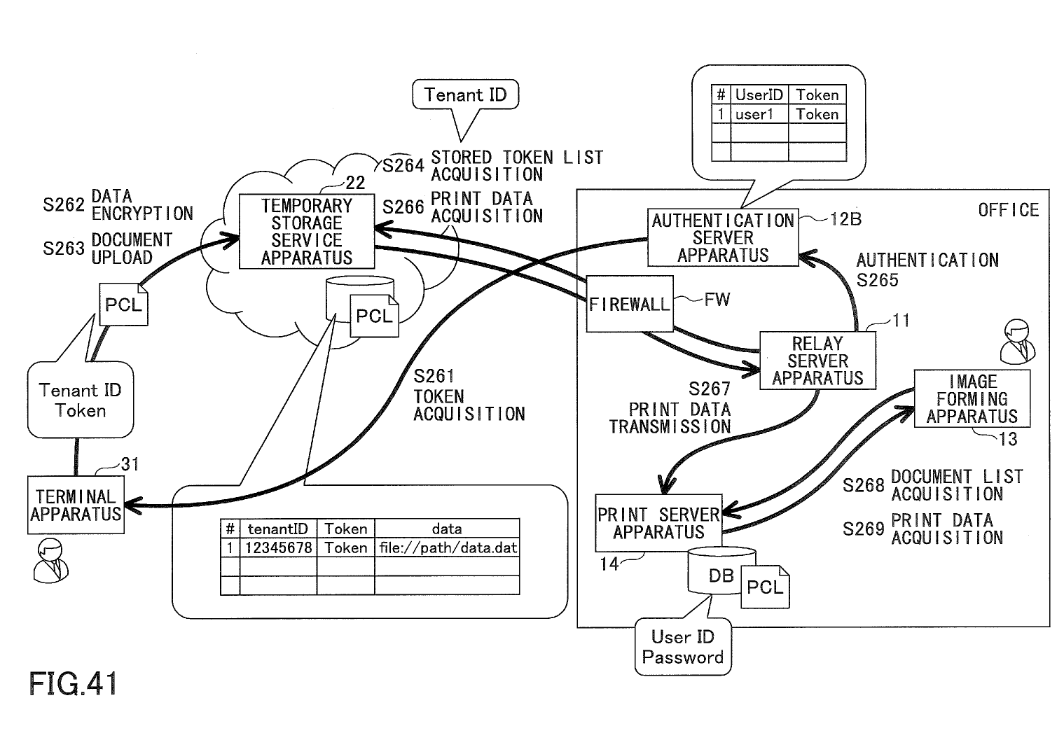

FIG. 41 schematically illustrates overall process operations of the print system according to the tenth embodiment. In step S261, a user makes a request to the authentication server apparatus 12B to generate a token, and acquires the generated token that is uniquely determined based on the user information of the user.

In step S262, when the user operates the terminal apparatus 31 and makes a request to have print data transmitted (uploaded) to the temporary storage service apparatus 22, the terminal apparatus 31 encrypts the print data using the acquired token as a public key.

In step S263, the terminal apparatus 31 transmits the encrypted print data together with the token acquired in step S261 to the temporary storage service apparatus 22. The temporary storage service apparatus 22 stores the encrypted print data and the token in association with each other. In step S264, the relay server apparatus 11 acquires from the temporary storage service apparatus 22 a token list including the token associated with the print data stored in the temporary storage service apparatus 22.

In step S265, the relay server apparatus 11 makes a request to the authentication server apparatus 12B to authenticate the token included in the token list acquired in step S264 and to acquire a secret key. In step S266, the relay server apparatus 11 acquires from the temporary storage services 22 the encrypted print data associated with the token that has been successfully authenticated. The relay server apparatus 11 decrypts the encrypted print data using the secret key (decryption key).

In step S267, the relay server apparatus 11 transmits the decrypted print data together with the user information registered in association with the token to the print server apparatus 14. The print server apparatus 14 stores the received print data in association with the user information. Note that step S268 and subsequent steps are substantially identical to step S237 and subsequent steps of FIG. 37, and as such, their descriptions are omitted.

In the print system 1 according to the tenth embodiment, a token that is uniquely determined based on user information is used to perform authentication at the authentication server apparatus 12B. Also, in the print system 1 according to the tenth embodiment, the token is used as an encryption key to encrypt print data. In this way, information security may be improved in the print system 1 according to the tenth embodiment.

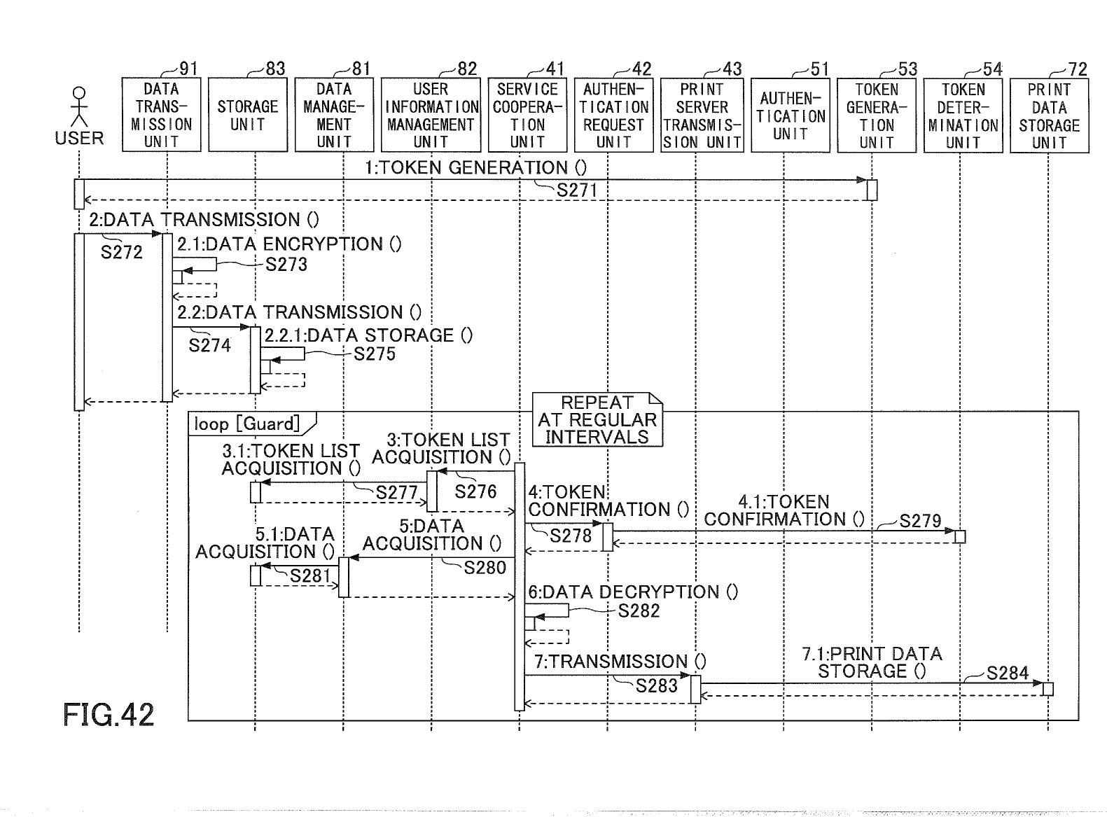

FIG. 42 is a sequence chart illustrating an exemplary submission/cooperation process of the print system according to the tenth embodiment. In step S271, the user makes a request to the token generation unit 53 of the authentication server apparatus 12B to generate a token, and acquires the generated token that is uniquely determined based on the user information. The token generation unit 53 of the authentication server apparatus 12B stores and manages the generated token in association with the user information that is uniquely determined based on the token as illustrated in FIG. 39. Note that the process of generating the token in step S271 may be performed using a web UI, for example. In step S272, the user operates the terminal apparatus 31 and makes a request to have print data transmitted to the temporary storage service apparatus 22. In step S273, the terminal apparatus 31 encrypts the print data using the acquired token as a public key.

In step S274, the data transmission unit 91 of the terminal apparatus 31 transmits the encrypted print data together with the token acquired in step S271 to the storage unit 83 of the temporary storage service apparatus 22. In step S275, the storage unit 83 stores the encrypted print data and the token received in step S274 in association with each other.

The service cooperation unit 41 of the relay server apparatus 11 may be activated at regular intervals, for example, and in step S276, the service cooperation unit 41 makes a token list acquisition request to the user information management unit 82 of the temporary storage service apparatus 22 to acquire a token list. In step S277, the user information managing unit 82 acquires from the storage unit 83 the corresponding token list including the token associated with the encrypted print data stored in the storage unit 83, and provides the acquired token list to the service cooperation unit 41 of the relay server apparatus 11.

In step S278, the service cooperation unit 41 makes a request to the authentication request unit 42 to authenticate the token included in the token list and to acquire a secret key. In step S279, the authentication request unit 42 makes a request to the token determination unit 54 of the authentication server apparatus 12B to authenticate the token included in the token list acquired from the temporary storage service apparatus 22.

The token determination unit 54 determines whether the token to be authenticated in response to the request from the relay server apparatus 11 matches a token generated by the token generation unit using the information of FIG. 39 and confirms successful authentication if a match is found. In steps S280 and S281, the service cooperation unit 41 of the relay server apparatus 11 acquires from the temporary storage service apparatus 22 the encrypted print data associated with the token that has been successfully authenticated.

In step S282, the service cooperation unit 41 of the relay server apparatus 11 decrypts the encrypted print data using the secret key. In steps S283 and S284, the service cooperation unit 41 of the relay server apparatus 11 transmits the decrypted print data together with the user information registered in association with the token to the print server apparatus 14. The print data storage unit 72 of the print server apparatus 14 stores the print data received from the relay server apparatus 11 in association with the user information.

As described above, in the print system 1 according to the tenth embodiment, a token is transmitted to the temporary storage service apparatus 22 instead of user information, and in this way, information security may be improved, for example. Also, in the print system 1 according to the tenth embodiment, the token is used as an encryption key to encrypt print data such that information security may be further improved, for example.

<Summary>

As described above, in the print system 1 according to the first to tenth embodiments of the present invention, user convenience may be improved, and the security of output data stored in the shared system 20 located outside the on-premises system 10 may be improved without increasing the operation load for user authentication management.

Although the present invention has been described above with reference to certain illustrative embodiments, the present invention is not limited to these embodiments, and numerous variations and modifications may be made without departing from the scope of the present invention. For example, in the embodiments described above, the print system 1 is illustrated as an example of an output system. However the present invention is not limited to print applications.

Note that the on-premises system 10 is an example of a first system that performs user authentication management based on first authentication information and outputs from an output apparatus output data stored by a user that has been authenticated. The shared system 20 is an example of a second system that is outside the first system and is configured to store output data transmitted from a terminal apparatus operated by a user and provide the output data to the first system.

The storage unit 83 is an example of a storage unit that stores the output data transmitted from the terminal apparatus and the first authentication information in association with each other. The user information management unit 82 is an example of an authentication information management unit that provides the first authentication information stored in the storage unit in response to a request from the first system. The data management unit 81 is an example of an output data management unit that provides the output data stored in the storage unit in response to a request from the first system.

The service cooperation unit 41 is an example of a cooperation unit that is configured to specify the output data stored in the storage unit that is associated with pre-authentication information that has been successfully authenticated by a first authentication unit as output data to be output by the first system.

The print server transmission unit 43 is an example of a transmission unit that is configured to transmit the output data acquired from the second system to an output data storage unit that stores the output data to be output by the output apparatus in association with the first authentication information used to authenticate the pre-authentication information.

The hash value of user information is an example of a calculated value that is obtained by applying a predetermined calculation procedure to the first authentication information. The conversion unit 84 is an example of a conversion unit for converting data received from the terminal apparatus into output data.

The user information history management unit 85 is an example of a history management unit for managing user information of a user that has provided output data to the first system as history information. The authentication unit 86 is an example of a second authentication unit that performs authentication for allowing use of the second system based on second authentication information.

The terminal ID management unit 87 is an example of a third authentication unit that performs authentication for allowing use of the second system based on identification information of the terminal apparatus. The temporary storage service apparatus 22 is an example of an output data storage apparatus. The relay server apparatus 11 is an example of an output data relay apparatus.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any non-transitory storage medium for storing processor readable code such as a floppy disk, a hard disk, a CD ROM, a magnetic tape device or a solid state memory device. The non-transitory storage medium can comprise any computer-readable medium except for a transitory, propagating signal.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Application No. 2014-187362 filed on Sep. 16, 2014, the entire contents of which are hereby incorporated by reference.

What is claimed is:

1. An output system comprising:
a first system configured to perform user authentication using user information including first authentication information, and output from an output apparatus output data specified using the first authentication information; and
a second system that is distinct from the first system and is configured to store output data received from a terminal apparatus that is operated by a user and provide the output data to the first system;
wherein the second system includes
a storage unit configured to receive from the terminal apparatus the output data and pre-authentication information to be authenticated at the first system, and store the output data and the pre-authentication information in association with each other;
an authentication information management unit configured to provide the pre-authentication information stored in the storage unit to the first system in response to a request from the first system; and
an output data management unit configured to provide the output data stored in the storage unit to the first system in response to a request from the first system; and
wherein the first system includes
an authentication information storage unit configured to store the user information including the first authentication information;
a first authentication unit configured to perform authentication with respect to the pre-authentication information that is provided by the second system based on the user information including the first authentication information stored in the authentication information storage unit;
a cooperation unit configured to specify the output data that is associated with the pre-authentication information that has been successfully authenticated by the first authentication unit as the output data to be output by the first system; and
an output data storage unit configured to store the specified output data in association with the first authentication information included in the user information used to authenticate the pre-authentication information that is associated with the specified output data.

2. The output system as claimed in claim 1, wherein
the second system includes
the storage unit that is configured to store the output data received from the terminal apparatus in association with a calculated value that is obtained by applying a predetermined calculation procedure to the pre-authentication information to be authenticated at the first system;
the authentication information management unit that is configured to provide the calculated value stored in the storage unit to the first system in response to a request from the first system; and
the output data management unit that is configured to provide the output data stored in the storage unit to the first system in response to a request from the first system; and
the first system includes
the authentication information storage unit that is configured to store the user information including the first authentication information;
the first authentication unit that is configured to perform authentication with respect to the calculated value that is provided by the second system based on the user information including the first authentication information stored in the authentication information storage unit;
the cooperation unit that is configured to specify the output data that is associated with the calculated value that has been successfully authenticated by the first authentication unit as the output data to be output by the first system; and
the output data storage unit that is configured to store the specified output data in association with the first authentication information included in the user information used to authenticate the calculated value that is associated with the specified output data.

3. The output system as claimed in claim 1, wherein
the second system further includes a conversion unit configured to convert data received from the terminal apparatus into the output data; and
the storage unit stores the output data converted by the conversion unit and the pre-authentication information in association with each other.

4. The output system as claimed in claim 3, wherein
the storage unit makes a request to the conversion unit to convert the data received from the terminal apparatus into the output data when the output data management unit is to provide the output data to the first system.

5. The output system as claimed in claim 4, wherein
the second system further includes a history management unit configured to manage information of the user that has provided the output data to the first system as history information;
the storage unit prompts the conversion unit to convert the data received from the terminal apparatus into the output data and stores the output data converted by the conversion unit in a case where the user operating the terminal apparatus has previously provided output data to the first system; and
the storage unit stores the data received from the terminal apparatus and prompts the conversion unit to convert the data into the output data upon providing the output data to the first system in case where the user operating the terminal apparatus has never provided output data to the first system.

6. The output system as claimed in claim 1, wherein
the second system further includes a second authentication unit configured to perform authentication for allowing use of the second system based on second authentication information; and
the storage unit stores the output data received from the terminal apparatus in a case where the authentication by the second authentication unit is successful.

7. The output system as claimed in claim 1, wherein
the second system further includes a third authentication unit configured to perform authentication for allowing use of the second system based on identification information of the terminal apparatus; and
the storage unit stores the output data received from the terminal apparatus in a case where the authentication by the third authentication unit is successful.

8. The output system as claimed in claim 1, wherein
the second system includes
the storage unit that is configured to receive from the terminal apparatus the output data and identification information of the terminal apparatus to be authenticated at the first system, and store the output data and the identification information of the terminal apparatus in association with each other;
the authentication information management unit that is configured to provide the identification information of the terminal apparatus stored in the storage unit to the first system in response to a request from the first system; and
the output data management unit that is configured to provide the output data stored in the storage unit to the first system in response to a request from the first system; and
the first system includes
the authentication information storage unit that is configured to store the user information including the first authentication information;
the first authentication unit that is configured to perform authentication with respect to the identification information of the terminal apparatus that is provided by the second system based on the user information including the first authentication information stored in the authentication information storage unit;
the cooperation unit that is configured to specify the output data that is associated with the identification information of the terminal apparatus that has been successfully authenticated by the first authentication unit as the output data to be output by the first system; and
the output data storage unit that is configured to store the specified output data in association with the first authentication information included in the user information used to authenticate the identification information of the terminal apparatus that is associated with the specified output data.

9. The output system as claimed in claim 1, wherein
the second system includes
the storage unit that is configured to receive from the terminal apparatus the output data and the pre-authentication information to be authenticated at the first system, and store the output data in association with a token associated with the user operating the terminal apparatus;
the authentication information management unit that is configured to provide the token stored in the storage unit to the first system in response to a request from the first system; and
the output data management unit that is configured to provide the output data stored in the storage unit to the first system in response to a request from the first system; and
the first system includes
the authentication information storage unit that is configured to store the user information including the first authentication information;
the first authentication unit that is configured to perform authentication with respect to the token that is provided by the second system based on the user information including the first authentication information stored in the authentication information storage unit;
the cooperation unit that is configured to specify the output data that is associated with the token that has been successfully authenticated by the first authentication unit as the output data to be output by the first system; and
the output data storage unit that is configured to store the specified output data in association with the first authentication information included in the user information used to authenticate the token that is associated with the specified output data.

10. The output system as claimed in claim 1, wherein
the second system includes
the storage unit that is configured to receive from the terminal apparatus the output data and the pre-authentication information to be authenticated at the first system, and store a token associated with the user operating the terminal apparatus and the output data that is encrypted by the token in association with each other;
the authentication information management unit that is configured to provide the token stored in the storage unit to the first system in response to a request from the first system; and
the output data management unit that is configured to provide the output data encrypted by the token that is stored in the storage unit to the first system in response to a request from the first system; and
the first system includes
the authentication information storage unit that is configured to store the user information including the first authentication information;
the first authentication unit that is configured to perform authentication with respect to the token that is provided by the second system based on the user information including the first authentication information stored in the authentication information storage unit;
the cooperation unit that is configured to specify the output data encrypted by the token that is that is associated with the token that has been successfully authenticated by the first authentication unit as the output data to be output by the first system; and
the output data storage unit that is configured to decrypt the specified output data encrypted by the token using a decryption key corresponding to the token, and store the decrypted output data in association with the first authentication information included in the user information used to authenticate the token that is associated with the specified output data.

11. The output system as claimed in claim 2, wherein
the second system further includes a conversion unit configured to convert data received from the terminal apparatus into the output data; and
the storage unit stores the output data converted by the conversion unit and the pre-authentication information in association with each other.

12. The output system as claimed in claim 11, wherein
the storage unit makes a request to the conversion unit to convert the data received from the terminal apparatus into the output data when the output data management unit is to provide the output data to the first system.

13. The output system as claimed in claim 12, wherein
the second system further includes a history management unit configured to manage information of the user that has provided the output data to the first system as history information;
the storage unit prompts the conversion unit to convert the data received from the terminal apparatus into the output data and stores the output data converted by the conversion unit in a case where the user operating the terminal apparatus has previously provided output data to the first system; and
the storage unit stores the data received from the terminal apparatus and prompts the conversion unit to convert the data into the output data upon providing the output data to the first system in case where the user operating the terminal apparatus has never provided output data to the first system.

14. The output system as claimed in claim 2, wherein
the second system further includes a second authentication unit configured to perform authentication for allowing use of the second system based on second authentication information; and
the storage unit stores the output data received from the terminal apparatus in a case where the authentication by the second authentication unit is successful.

15. The output system as claimed in claim 2, wherein
the second system further includes a third authentication unit configured to perform authentication for allowing use of the second system based on identification information of the terminal apparatus; and
the storage unit stores the output data received from the terminal apparatus in a case where the authentication by the third authentication unit is successful.

16. The output system as claimed in claim 3, wherein
the second system further includes a second authentication unit configured to perform authentication for allowing use of the second system based on second authentication information; and
the storage unit stores the output data received from the terminal apparatus in a case where the authentication by the second authentication unit is successful.

17. The output system as claimed in claim 3, wherein
the second system further includes a third authentication unit configured to perform authentication for allowing use of the second system based on identification information of the terminal apparatus; and
the storage unit stores the output data received from the terminal apparatus in a case where the authentication by the third authentication unit is successful.

18. The output system as claimed in claim 4, wherein
the second system further includes a second authentication unit configured to perform authentication for allowing use of the second system based on second authentication information; and
the storage unit stores the output data received from the terminal apparatus in a case where the authentication by the second authentication unit is successful.

19. An output method implemented by an output system including a first system configured to perform user authentication using user information including first authentication information and output from an output apparatus output data specified using the first authentication information, and a second system that is distinct from the first system and is configured to store output data received from a terminal apparatus that is operated by a user and provide the output data to the first system, the output method comprising:
steps implemented by the second system including
receiving from the terminal apparatus the output data and pre-authentication information to be authenticated at the first system, and storing the output data and the pre-authentication information in association with each other in a storage unit;
providing the pre-authentication information stored in the storage unit to the first system in response to a request from the first system; and
providing the output data stored in the storage unit to the first system in response to a request from the first system; and
steps implemented by the first system including
storing the user information including the first authentication information in an authentication information storage unit;
performing authentication with respect to the pre-authentication information that is provided by the second system based on the user information including the first authentication information stored in the authentication information storage unit;
prompting a cooperation unit to specify the output data that is associated with the pre-authentication information that has been successfully authenticated by the first authentication unit as the output data to be output by the first system; and
storing the specified output data in association with the first authentication information included in the user information used to authenticate the pre-authentication information that is associated with the specified output data.

20. An output data storage apparatus that is included in a second system of an output system including a first system and the second system, the first system being configured to perform user authentication using user information including first authentication information and output from an output apparatus output data specified using the first authentication information, and the second system being distinct from the first system and being configured to store output data received from a terminal apparatus that is operated by a user and provide the output data to the first system, the output data storage apparatus comprising:
a storage unit configured to receive from the terminal apparatus the output data and pre-authentication information to be authenticated at the first system, and store the output data and the pre-authentication information in association with each other;
an authentication information management unit configured to provide the pre-authentication information stored in the storage unit to the first system in response to a request from the first system; and
an output data management unit configured to provide the output data stored in the storage unit to the first system in response to a request from the first system.
